(19) United States
(12) Patent Application Publication
(10) Pub. No.: US 2024/0319482 A1
(43) Pub. Date: Sep. 26, 2024

(54) MWIR ORTHOSCOPIC LENS

(71) Applicant: BAE Systems Information and Electronic Systems Integration Inc., Nashua, NH (US)

(72) Inventors: Mark L. Oskotsky, Mamaroneck, NY (US); Michael J. Russo, JR., Roslyn, NY (US); Daniel Engheben, Commack, NY (US)

(73) Assignee: BAE Systems Information and Electronic Systems Integration Inc., Nashua, NH (US)

(21) Appl. No.: 18/056,751

(22) Filed: Nov. 18, 2022

(51) Int. Cl. G02B 13/14; G02B 13/18

(52) U.S. Cl. CPC G02B 13/14; G02B 13/18

(57) ABSTRACT

A mid-wave infrared (MWIR) lens assembly that may include a first set of optical elements, wherein each optical element of the first set of optical elements is a positive optical power. MWIR lens assembly may also include a second set of optical elements, wherein each optical element of the second set of optical elements is a negative optical power. MWIR lens assembly may also include that at least one optical element of the first set of optical elements is formed of a first optical glass material, at least another optical element of the first set of optical elements is formed of a second optical glass material, and at least one optical element of the second set of optical elements is formed of a third optical glass material wherein the second optical glass material is different than the first optical glass material and the third optical glass material.

### STATEMENT OF GOVERNMENT INTEREST

This invention was made with government support under Contract No. W909MY awarded by government agency Night Vision and Electronic Sensors Directorate (NVESD). The government has certain rights in the invention.

### TECHNICAL FIELD

The present disclosure relates generally to the field of orthoscopic imaging optics working within the mid-wave infrared (MWIR) spectrums.

### BACKGROUND

Imaging performed in the mid-wave infrared (MWIR) spectrum (e.g., in the wavelength range from 4900 nm to 3000 nm) are commonly utilized in airborne platforms. For example, MWIR optical systems may be deployed on airborne platforms for diverse applications, including reconnaissance applications, surveillance applications, and mapping applications. These airborne MWIR optical systems are needed to obtain and store substantially large quantities of high resolution images such that extensive post-acquisition processing of the images is avoided.

With these optical systems, special requirements may apply to MWIR optical systems that are deployed on airborne platforms. In one instance, lenses of optical systems must have a specific focal length to entrance pupil diameter ratio (F #) to obtain fine spatial resolution while also providing a suitable energy flux to image plane detectors of these optical systems. Such features mentioned in this instance must lead to a sufficient signal-to-noise ratio for the image of the remote target.

With such specific requirements, optics and elements of optical systems used in multiple airborne applications, including surveillance applications and mapping applications for airborne platforms, must also be capable of having wide field of views in order to enable the optical system to cover large areas of observation. With such requirements of having wide field of views, images processed during these applications must have proper mapping and recognition of remote objects of interest in which the images shall not be distorted; in other words, these specific optics and elements of MWIR optical system are desired to be orthoscopic. Current MWIR lenses and systems in airborne application, however, tend to include systems that are selected to correct or compensate but are unable or incapable of correcting or compensating for distortion. Such lack of correcting or compensating for distortion may lead to improper focusing of MWIR radiation or light from certain points on the remote object at incorrect distances from an optical axis at the image plane. With such incorrect distances, the distances from the optical axis to the imaged features of the object fail to be linearly proportional to the dimensions of the object. For example, if the distances between projected points of the image increase more rapidly than between corresponding points of the object, then “pincushion” distortion occurs. In another example, if the distances between projected points of the image decrease more rapidly than between corresponding points of the object, then “barrel distortion” distortion occurs.

To combat this distortion, distortions induced by each optical element in the lens assembly should be minimal or should be mutually compensated. However, current MWIR lenses and systems currently used in airborne optical applications fail to correct for these types of distortions when used in various airborne applications. Moreover, in order to have an imaging without stray light or narcissus, MWIR projection lens should include approximately 100% cold shield efficiency.

Some current items disclose projection lens system which includes at least one molded chalcogenide lens element that is configured to simultaneously image light in the medium wave (MWIR) and the long wave infrared (LWIR) regions at a common focal plane. However, the lens in these items do not have a cold shield and cannot be used with a high resolution infrared detectors.

Other systems disclose a wide-angle MWIR F-theta lens with an F # of 2. The lens disclosed in one example is deployed on airborne platforms for remote sensing applications and is corrected for monochromatic and chromatic aberrations over the wavelength range of 3.3 micrometers to 5.1 micrometers. The image of the remote target is formed on a focal plane which may constitute CCD or CMOS with micro lenses. However, the lens is large and expansive by comprising four groups of optical elements with a cold shield/aperture stop located behind the last group, and one embodiment of the lens includes five types of optical materials while another embodiment of the lens includes only two types of optical materials.

Another system discloses a wide field of view monocentric lens system for an infrared aerial reconnaissance camera which includes front and rear lens monocentric components. Shape of the optical elements depends on the IR band of interest (LWIR, MWIR or SWIR). However, lens does not have a cold shield and cannot be used with high resolution infrared detectors.

A further item discloses an airborne infrared MWIR prime lens which consists of six optical elements. The lens is compact with a length of only 116.5 mm. However, this lens is not suitable for scanning airborne systems.

Another system discloses a continuous zoom lens arrangement that may image MWIR and LWIR spectral bands to a common image plane. It also discloses a continuous zoom lens with a F # of 3. However, the continuous zoom lens only provides low resolution utilizing a 640×480 element focal plane array with 20 micron square pixels.

Another item discloses a zoom lens consisting of five groups of optical elements and has a long overall length, but the lens does not incorporate a cold shield and cannot be used for the airborne optics with high resolution infrared detectors.

A further system includes properties of the IR materials, color correction, and optical doublet configurations. The system also suggests optical system using Cooke structure with a wavelength range both middle and long wavelength infrared (MWIR and LWIR, i.e. 3-5 μm and 8-12 μm). Through the method of optical passive athermalization, the lens suggested herein can be suitable for working in the environmental temperature of −60-80° C. Lens suggested herein may include four optical elements made from Ge, ZnSe and ZnS.

A further system works only in the visible spectrum of 900 nm-450 nm. This wide field of view orthoscopic lens consists of five optical groups and is achromatic and athermal.

### SUMMARY

Each of the identified current lenses suffers from one or more of the shortcomings described above.

The present disclosure addressed these and other issues providing at least one lens assembly with a low F # and a long focal length for high resolution aerial reconnaissance and surveillance while further being orthoscopic and providing a large field of view. Moreover, the presently disclosed lens assembly may utilize only two types of optical glass material allowing the lens to be reduced in size, cost, and weight while further reducing and minimizing the complexity thereof. Furthermore, the presently disclosed lens assembly is also configured to correct for both monochromatic and chromatic aberrations over the wavelength range of approximately 4900 nanometers to approximately 3300 nanometers.

In one aspect, an exemplary embodiment of the present disclosure may provide a mid-wave infrared (MWIR) lens assembly. MWIR lens assembly comprises a first set of optical elements, wherein each optical element of the first set of optical elements has a positive optical power. MWIR lens assembly also comprises a second set of optical elements, wherein each optical element of the second set of optical elements is a negative optical power. MWIR lens assembly also comprises a cold shield positioned optically behind the first set of optical elements and the second set of optical elements relative to a direction that light waves move through the first set and the second set of optical elements. MWIR lens assembly also comprises an image plane detector positioned optically behind the first set of optical elements, the second set of optical elements, and the cold shield. Additionally, at least one optical element of the first set of optical elements is formed of a first optical glass material, at least another optical element of the first set of optical elements is formed of a second optical glass material, and at least one optical element of the second set of optical elements is formed of a third optical glass material; wherein the second optical glass material is different than the first optical glass material and the third optical glass material.

This exemplary embodiment or another exemplary embodiment may further include that the first set of optical elements and the second set of optical elements further comprises: five total optical elements with two optical elements in the first set of optical elements and three optical elements in the second set of optical elements. This exemplary embodiment or another exemplary embodiment may further include that the five total optical elements of the first set of optical elements and the second set of optical elements are arranged in order from an object to the image plane detector as a first optical element having a negative optical power, a second optical element having a positive optical power, a third optical element having a positive optical power, a fourth optical power having a negative optical power, and a fifth optical power having a positive optical power. This exemplary embodiment or another exemplary embodiment may further include that the first optical glass material further comprises a Germanium material; the second optical glass material further comprises a Silicon material; and the third optical glass material further comprises a Germanium material. This exemplary embodiment or another exemplary embodiment may further include that the third optical element is made from the first optical glass material, the second optical element and the fifth optical element are made from the second optical glass material, and the first optical element and the fourth optical element are made from the third optical glass material. This exemplary embodiment or another exemplary embodiment may further include that the first optical element further comprises: a double concave lens having a first surface of the first optical element that is oriented towards the object and a second surface of the first optical element that is oriented opposite towards the image plane detector; wherein the second surface of the first optical element that is formed aspherical. This exemplary embodiment or another exemplary embodiment may further include that the second optical element further comprises: a positive meniscus lens having a first surface of the second optical element that is oriented towards the object and a second surface of the second optical element that is oriented opposite towards the image plane detector; wherein the first surface of the second optical element is a concave surface of the positive meniscus lens and is formed aspherical. This exemplary embodiment or another exemplary embodiment may further include that the third optical element further comprises: a positive meniscus lens having a first surface of the third optical element that is oriented towards the object and a second surface of the third optical element that is oriented towards the image file detector; wherein the second surface of the third optical element is a concave surface of the positive meniscus lens and is formed aspherical. This exemplary embodiment or another exemplary embodiment may further include that the fourth optical element further comprises: a negative meniscus lens having a first surface of the fourth optical element that is oriented towards the object and a second surface of the fourth optical element that is oriented towards the image plane detector; wherein the second surface of the fourth optical element that is a concave surface of the negative meniscus lens. This exemplary embodiment or another exemplary embodiment may further include that the fifth optical element further comprises: a positive meniscus lens having a first surface of the fifth optical element that is oriented towards the object and a second surface of the fifth optical element that is oriented opposite towards the image plane detector; wherein the first surface is a concave surface of the positive meniscus lens and is formed aspherical. This exemplary embodiment or another exemplary embodiment may further include an orthoscopic lens with residual distortion not exceeding 0.03% over a full field of view; and a F # of 2.2. This exemplary embodiment or another exemplary embodiment may further include that the first optical element further comprises: a negative meniscus lens having a first surface of the first optical element oriented towards the object and a second surface of the first optical element oriented towards the image file detector; wherein second surface of the first optical element is a concave surface of the negative meniscus lens and is formed aspherical. This exemplary embodiment or another exemplary embodiment may further include that the second optical element further comprises: a positive meniscus lens having a first surface of the second optical element oriented towards the object and a second surface of the second optical element oriented towards the image plane detector; wherein the first surface is a concave surface of the positive meniscus lens and is formed aspherical. This exemplary embodiment or another exemplary embodiment may further include that the third optical element further comprises: a positive meniscus lens having a first surface of the third optical element oriented towards the object and a second surface of the third optical element oriented towards the image file detector; wherein the second surface is a concave surface of the positive meniscus lens and is formed aspherical. This exemplary embodiment or another exemplary embodiment may further include that the fourth optical element further comprises: a negative meniscus lens having a first surface of the fourth optical element oriented towards the image plane detector and a second surface of the fourth optical element oriented towards the image plane detector; wherein the first surface is a concave surface of the negative meniscus lens. This exemplary embodiment or another exemplary embodiment may further include that the fifth optical element further comprises: a positive meniscus lens having a first surface of the fifth optical element oriented towards the object and a second surface of the fifth optical element oriented towards the image plane detector; wherein the first surface is a concave surface of the positive meniscus lens and is formed aspherical. This exemplary embodiment or another exemplary embodiment may further include an orthoscopic lens with residual distortion not exceeding 0.1% over a full field of view; and a F # of 2.

In another aspect, an exemplary embodiment of the present disclosure may provide a method. The method may include steps of receiving light emitted from an object; directing the light through a first set of optical elements, wherein each optical element of the first set of optical elements has a positive optical power with at least one optical element of the first set of optical elements formed a first optical glass material and at least another optical element of the first set of optical elements formed of a second optical glass material; directing the light through a second set of optical elements, wherein each optical element of the second set of optical elements has a negative optical power with at least one optical element of the second set of optical elements formed a third optical glass material; wherein the second optical glass material is different than the first optical glass material and the third optical glass material; directing the light with an image plane detector; and generating an image from the image plane detector.

This exemplary embodiment or another exemplary embodiment may further include that the steps of directing the light through the first set of optical elements and directing the light through the second set of optical elements further comprises: directing the light through a first optical element having double concave lens and a negative optical power, the first optical element having a first surface and a second surface wherein the second surface of the first optical element is aspherical; directing the light through a second optical element having a positive meniscus formed with a concave surface facing towards the object and with a positive optical power, the second optical element having a first surface and a second surface wherein the first surface of the second optical element is aspherical; directing the light through a third optical element having a positive meniscus formed with a concave surface facing towards the image plane detector and with a positive optical power, the third optical element having a first surface and a second surface wherein the second surface of the third optical element is aspherical; directing the light through a fourth optical element having a negative meniscus formed with a concave surface facing towards the object and with a negative optical power; and directing the light through a fifth optical element having a positive meniscus formed with a concave surface facing towards the object and with a positive optical power, the fifth optical element having a first surface and a second surface wherein the first surface of the fifth optical element is aspherical. This exemplary embodiment or another exemplary embodiment may further include that the steps of directing the light through the first set of optical elements and directing the light through the second set of optical elements further comprises: directing the light through a first optical element having a negative meniscus formed with a concave surface facing towards the image plane detector and with a negative optical power, the first optical element having a first surface and a second surface wherein the second surface of the first optical element is aspherical; directing the light through a second optical element having a positive meniscus formed with a concave surface facing towards the object and with a positive optical power, the second optical element having a first surface and a second surface wherein the first surface of the second optical element is aspherical; directing the light through a third optical element having a positive meniscus formed with a concave surface facing towards the image plane detector and with a positive optical power, the third optical element having a first surface and a second surface wherein the second surface of the third optical element is aspherical; directing the light through a fourth optical element having a negative meniscus formed with a concave surface facing towards the object and with a negative optical power; and directing the light through a fifth optical element having a positive meniscus formed with a concave surface facing towards the object and with a positive optical power, the fifth optical element having a first surface and a second surface wherein the first surface of the fifth optical element is aspherical.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a schematic view of an exemplary orthoscopic mid-wave infrared (MWIR) lens assembly according to one aspect of the present disclosure.

FIG. 2A (FIG. 2A) is a first data graph showing a diffraction modulation transfer function (MTF) at half-Nyquist data based on the orthoscopic MWIR lens assembly shown in FIG. 1.

FIG. 2B (FIG. 2B) is a second data graph showing a diffraction modulation transfer function (MTF) at half-Nyquist data based on the orthoscopic MWIR lens assembly shown in FIG. 1.

FIG. 2C (FIG. 2C) is a third data graph showing a diffraction modulation transfer function (MTF) at half-Nyquist data based on the orthoscopic MWIR lens assembly shown in FIG. 1.

FIG. 2D (FIG. 2D) is a fourth data graph showing a diffraction modulation transfer function (MTF) at half-Nyquist data based on the orthoscopic MWIR lens assembly shown in FIG. 1.

FIG. 3A (FIG. 3A) is a first graph of astigmatism of the orthoscopic MWIR lens assembly shown in FIG. 1.

FIG. 3B (FIG. 3B) is a second graph of astigmatism of the orthoscopic MWIR lens assembly shown in FIG. 1.

FIG. 3C (FIG. 3C) is a third graph of astigmatism of the orthoscopic MWIR lens assembly shown in FIG. 1.

FIG. 3D (FIG. 3D) is a fourth graph of astigmatism of the orthoscopic MWIR lens assembly shown in FIG. 1.

FIG. 3E (FIG. 3E) is a fifth graph of astigmatism of the orthoscopic MWIR lens assembly shown in FIG. 1.

FIG. 3F (FIG. 3F) is a graph of distortion of the orthoscopic MWIR lens assembly shown in FIG. 1.

FIG. 4 (FIG. 4) is a graph of lateral color of a field of view of the orthoscopic MWIR lens assembly shown in FIG. 1.

FIG. 5A (FIG. 5A) is a first portion of a table listing properties of optical elements of the orthoscopic MWIR assembly lens shown in FIG. 1.

FIG. 5B (FIG. 5B) is a second portion of the table of FIG. 5A listing properties of optical elements of the orthoscopic MWIR assembly lens shown in FIG. 1.

FIG. 6 (FIG. 6) is a schematic view of another exemplary orthoscopic MWIR assembly lens according to another aspect of the present disclosure.

FIG. 7A (FIG. 7A) is a first data graph showing a diffraction modulation transfer function (MTF) at half-Nyquist data based on the orthoscopic MWIR lens assembly shown in FIG. 6.

FIG. 7B (FIG. 7B) is a second data graph showing a diffraction modulation transfer function (MTF) at half-Nyquist data based on the orthoscopic MWIR lens assembly shown in FIG. 6.

FIG. 7C (FIG. 7C) is a third data graph showing a diffraction modulation transfer function (MTF) at half-Nyquist data based on the orthoscopic MWIR lens assembly shown in FIG. 6.

FIG. 7D (FIG. 7D) is a fourth data graph showing a diffraction modulation transfer function (MTF) at half-Nyquist data based on the orthoscopic MWIR lens assembly shown in FIG. 6.

FIG. 8A (FIG. 8A) is a first graph of astigmatism of the orthoscopic MWIR lens assembly shown in FIG. 6.

FIG. 8B (FIG. 8B) is a second graph of astigmatism of the orthoscopic MWIR lens assembly shown in FIG. 6.

FIG. 8C (FIG. 8C) is a third graph of astigmatism of the orthoscopic MWIR lens assembly shown in FIG. 6.

FIG. 8D (FIG. 8D) is a fourth graph of astigmatism of the orthoscopic MWIR lens assembly shown in FIG. 6.

FIG. 8E (FIG. 8E) is a fifth graph of astigmatism of the orthoscopic MWIR lens assembly shown in FIG. 6.

FIG. 8F (FIG. 8F) is a graph of distortion of the orthoscopic MWIR lens assembly shown in FIG. 6.

FIG. 9 (FIG. 9) is a graph of lateral color of a field of view of the orthoscopic MWIR lens assembly shown in FIG. 6.

FIG. 10A (FIG. 10A) is a first portion of a table listing properties of optical elements of the orthoscopic MWIR lens assembly shown in FIG. 6.

FIG. 10B (FIG. 10B) is a second portion of the table in FIG. 10A listing properties of optical elements of the orthoscopic MWIR lens assembly shown in FIG. 6.

FIG. 11 (FIG. 11) is an exemplary method flowchart.

Similar numbers refer to similar parts throughout the drawings.

### DETAILED DESCRIPTION

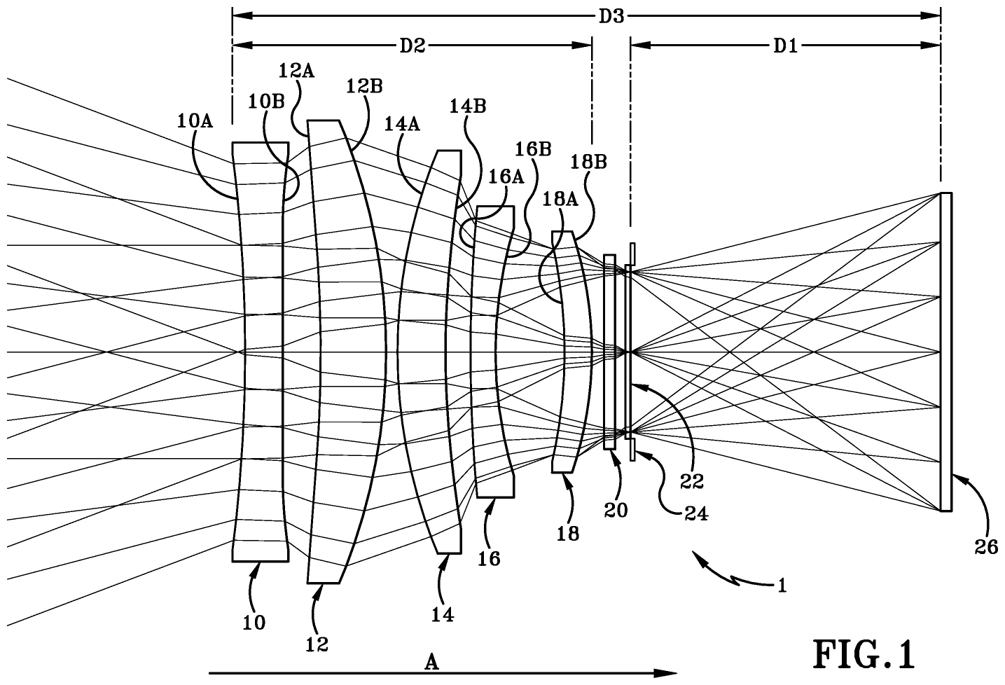

As illustrated in FIG. 1, a mid-wave infrared (MWIR) imaging lens assembly is generally referenced at 1. Generally, lens assembly 1 may include several optical elements, namely, a first optical element 10, a second optical element 12, a third optical element 14, a fourth optical element 16, and a fifth optical element 18. As described in more detail below, the second optical element 12, the third optical element 14, and the fifth optical element 18 form a first set of optical elements of the lens assembly 1, and the first optical element 10 and the fourth optical element 16 form a second set of optical elements of the lens assembly 1.

Generally, the lens assembly 1 may be an apochromatic and orthoscopic MWIR imaging lens operable with the wide MWIR spectrum ranging from approximately 3000 nanometers to approximately 5000 nanometers. More particularly, the lens assembly 1 may be an apochromatic and orthoscopic MWIR imaging lens operable with the wide MWIR spectrum ranging from approximately 3300 nanometers to approximately 5000 nanometers. Specifically, the lens assembly 1 may be an apochromatic and orthoscopic MWIR imaging lens operable with the wide MWIR spectrum ranging from approximately 3300 nanometers to approximately 4900 nanometers. Additionally, the lens assembly 1 includes the following specifications and/or features regarding a F #, an instantaneous field of view measurement (IFOV), a focal length (EFL), and an overall length (OAL):

| F# | 2.2 | |
|---|---|---|
| Pixel Size | 8 | μm |
| IFOV | 88.5 | μrad |
| EFL | 3.56 | inches |
| Distortion | <1% | |
| MTF | >0.4 cross field, at half-Nyquist 31.25 lp/mm | |
| OAL | 5.8 | inches |

As best seen in FIG. 1, the first optical element 10 through the fifth optical element 18 may be determined by their position within lens assembly 1 based on the order in which each optical element may encounter light entering through the lens assembly 1. Specifically, as indicated by arrow A in FIG. 1, light may initially enter through the first optical element 10 and then pass through the remaining second optical element 12 through the fifth optical element 18. Accordingly, each element may be numbered relative to their position in this path. However, it will be understood than any numbering convention may be used, as desired. It is also contemplated that each optical element 10, 12, 14, 16, 18 may be constructed and/or formed of any suitable material. In one aspect, it is contemplated that each optical element 10, 12, 14, 16, 18 will be formed of one of two types of optical glass material found to impart the desired properties into the lens assembly 1. Accordingly, as detailed below, each optical element 10, 12, 14, 16, 18 may be formed of commercially available Germanium material or Silicon material. Moreover, at least one surface of at least one optical element 10, 12, 14, 16, 18 may be shaped to a specific orientation and may be one of spherical and aspherical for various reasons, including allowing correction of monochromatic aberrations along with correction of axial and lateral chromatic aberrations and distortions; such configurations of these optical elements 10, 12, 14, 16, 18 are described in further detail below

As best seen in FIG. 1, the first optical element 10 of the lens assembly 1 is the initial optical element in the order of the lens assembly 1. Based on the order of the lens assembly 1, the first optical element 10 is configured to initially receive diverged light emitted from a remote object located at a distance away from the lens assembly 1. The first optical element 10 is also configured to direct the diverged light received from the remote object onto the second optical element 12.

As best seen in FIG. 1, the first optical element 10 includes a first surface 10A that faces towards the remote object located away from the lens assembly 1. The first optical element 10 also includes a second surface 10B that faces in an opposite direction of the first surface 10A and faces towards the second optical element 12. In one aspect, the first surface 10A and the second surface 10B of the first optical element 10 forms a double concave lens for the first optical element 10 and is configured with a negative optical power. The first surface 10A of the first optical element 10 is formed spherically. The second surface 10B of the first optical element 10 is also formed aspherical in order to correct for the low order spherical aberration and high order spherical aberration across the field of view. Moreover, the first optical element 10 is made of Germanium material.

As best seen in FIG. 1, the second optical element 12 of the lens assembly 1 is the second element in the order of the lens assembly 1. Based on the order of the lens assembly 1, the second optical element 12 is configured to receive the diverged light emitted from the first optical element 10. The second optical element 12 is also configured to converge the light from the first optical element 10 and to direct the diverged light received from the first optical element 10 onto the third optical element 14.

As best seen in FIG. 1, the second optical element 12 includes a first surface 12A that faces towards the first optical element 10 of the lens assembly 1 and/or the remote object. The second optical element 12 also includes a second surface 12B that faces in an opposite direction of the first surface 12A and faces towards the third optical element 14. According to one aspect, the second optical element 12 is made in a form of a positive meniscus where the first surface 12A is a concave surface that faces towards the remote object, and the second optical element 12 is also configured with a positive optical power. The first surface 12A of the second optical element 12 is formed aspherical in order to correct for high order spherical aberration across the field of view. The second surface 12B of the second optical element 12 is also formed spherically. Moreover, the second optical element 12 is made of Silicon material.

As best seen in FIG. 1, the third optical element 14 of the lens assembly 1 is the third element in the order of the lens assembly 1. Based on the order of the lens assembly 1, the third optical element 14 is configured to receive and further converge the light directed from the second optical element 12. The third optical element 14 is also configured to further direct the converged light received from the second optical element 12 onto the fourth optical element 16.

As best seen in FIG. 1, the third optical element 14 includes a first surface 14A that faces towards the second optical element 12 of the lens assembly 1 and/or the remote object. The third optical element 14 also includes a second surface 14B that faces in an opposite direction of the first surface 14A and faces towards the fourth optical element 16. According to one aspect, the third optical element 14 is made in a form of a positive meniscus where the second surface 14B is a concave surface that faces towards an image plane detector of the lens assembly 1, which is described in more detail below. The first surface 14A of the third optical element 14 is formed spherically. The second surface 14B of the third optical element 14 is also formed aspherical in order to correct for high order coma correction. Moreover, the third optical element 14 is made of Germanium material.

As best seen in FIG. 1, the fourth optical element 16 of the lens assembly 1 is the fourth element in the order of the lens assembly 1. Based on the order of the lens assembly 1, the fourth optical element 16 is configured to receive the converged light directed from the third optical element 14. The fourth optical element 16 is also configured to diverge the light and direct the diverged light onto the fifth optical element 18.

As best seen in FIG. 1, the fourth optical element 16 includes a first surface 16A that faces towards the third optical element 14 of the lens assembly 1 and/or the remote object. The fourth optical element 16 also includes a second surface 16B that faces in an opposite direction of the first surface 16A and faces towards the fifth optical element 18. According to one aspect, the fourth optical element 16 is made in a form of a negative meniscus where the first surface 16A is a concave surface that faces towards the remote object positioned away from the lens assembly 1. Moreover, the fourth optical element 16 is made of Germanium material.

As best seen in FIG. 1, the fifth optical element 18 of the lens assembly 1 is the fifth element in order of the lens assembly 1. Based on the order of the lens assembly 1, the fifth optical element 18 is configured to receive the diverged light directed from the fourth optical element 16. The fifth optical element 18 is also configured to direct the diverged light received from the fourth optical element 16 onto a filter of the lens assembly 1, which is described in more detail below.

As best seen in FIG. 1, the fifth optical element 18 includes a first surface 18A that faces towards the fourth optical element 16 of the lens assembly 1 and/or the remote object. The fifth optical element 18 also includes a second surface 18B that faces in an opposite direction of the first surface 18A and faces towards the filter of the lens assembly 1. According to one aspect, the fifth optical element 18 is made in a form of a positive meniscus where the first surface 18A is a concave surface that faces towards the remote object positioned away from the lens assembly 1. The first surface 18A of the fifth optical element 18 is formed aspherical in order to correct for residual coma and sagittal astigmatism. The second surface of the fifth optical element 18B is also formed spherically. Moreover, the fifth optical element 18 is made of Silicon material.

The optical powers and shapes of the first optical element 10, the second optical element 12, the third optical element 14, the fourth optical element 16, and the fifth optical element 18 may be selected, along with the choice of materials and special usage of high order aspherical surfaces, to enable correction of monochromatic aberrations along with correction of axial and lateral chromatic aberrations and distortion. As such, the optical powers, the shapes, the refractive indices, and the dispersions of materials of the optical elements 10, 12, 14, 16, 18 are selected such that the lens assembly 1 is both apochromatic and orthoscopic. The lens assembly 1 described herein is configured to be used in a scanning airborne system of an aircraft in a configuration where a scan mirror is loaded forwardly of the lens assembly 1, specifically forward of the first optical element 10 of the lens assembly 1. Moreover, the lens distortion of lens assembly 1 is less than 0.03% in which the lens assembly 1 is corrected for both monochromatic and chromatic aberrations over the wavelength range from about 4900 nm to about 3300 nm.

The optical powers and shapes of the first optical element 10, the second optical element 12, the third optical element 14, the fourth optical element 16, and the fifth optical element 18 may be selected, along with the glass refractive indices and dispersion, to enable correction of cross field monochromatic and chromatic aberrations. In this present aspect, the lens assembly 1 is configured with a wide angle field of view of about 37.5 degree along with achieving a F #2.2 value while having a desired distance of about 2.6 inches measured from the cold shield 24 to the image plane detector 26. In this present aspect, the lens assembly 1 is also compact in structural configuration and is configured to utilize one or both of the only two optical materials, particularly Germanium and Silicon.

As best seen in FIG. 1, the lens assembly 1 also includes filter 20. The filter 20 is the sixth element in order of the lens assembly 1 positioned longitudinally behind (relative to directional Arrow A) and/or positioned adjacent to the fifth optical element 18. The lens assembly 1 also includes Dewar window 22. The Dewar window 22 is the seventh element in order of the lens assembly 1 positioned longitudinally behind and/or positioned adjacent to the filter 20.

As best seen in FIG. 1, the lens assembly 1 also includes cold shield 24. The cold shield 24 is the eighth element in order of the lens assembly 1 positioned longitudinally behind the fifth optical element 18 and positioned longitudinally behind and/or positioned adjacent to the Dewar window 22. The cold shield 24 is also positioned longitudinally ahead of and/or position forward of an image plane detector 26 of the lens assembly 1. In one instance, the cold shield 24 is approximately one hundred percent efficient and is the aperture stop for lens assembly 1.

As best seen in FIG. 1, a first distance D1 is measured from the cold shield 24 to the image plane detector 26. In one example, the first distance D1 that is measured from the cold shield 24 to the image plane detector 26 is about 2.6 inches. As best seen in FIG. 1, a second distance D2 is measured from the first optical element 10 to the fifth optical element 18 in which the second distance D2 is the focal length of the lens assembly 1. In one example, the second distance that is measured from the first optical element 10 to the fifth optical element 18 is about 3.56 inches. As best seen in FIG. 1, a third distance D3 is measured from the first optical element 10 to the image plane detector 26 in which the third distance D3 defines the entire length of the lens assembly 1. In one example, the third distance D3 that is measured from the first optical element 10 to the image plane detector 26 is about 5.8 inches which defines the entire length of the lens assembly 1.

With continued referenced to FIG. 1, the first optical element 10, the second optical element 12, the third optical element 14, the fourth optical element 16, and the fifth optical element 18 are numbered and arranged such that the first optical element 10 is positioned closest to the remote object in the far field while the fifth optical element 18 is positioned closest to and/or adjacent to the filter 20, the Dewar window 22, and the cold shield 24. Accordingly, it will be understood that these optical elements 10, 12, 14, 16, 18 are numbered in order from the remote object to the filter 20, the Dewar window 22, the cold shield 24, and the image plane detector 26 and may be numbered in any other suitable order or position. Generally, lens assembly 1 may include a housing or similar structure containing each of the component described herein, as dictated by the desired implementation. Such housing is not shown in FIG. 1 but may be included in any suitable position, shape, form, and/or with any desired features, as dictated by the desired implementation.

Filter 20 may be a standard and/or commercially available filter as desired according to a specific implementation of lens assembly 1. Dewar window 22 may also be a standard and/or commercially available Dewar window as desired according to a specific implementation of lens assembly 1. Cold shield 24 may also be a standard and/or commercially available cold shield as desired according to a specific implementation of lens assembly 1. Image plane detector 26 may also be a standard and/or commercially available image plane detector as desired according to a specific implementation of lens assembly 1.

For lens assembly 1, according to one aspect, the following relations among the optical powers and the materials that form the optical elements 10, 12, 14, 16, 18 have been found to achieve orthoscopy, flat field, and monochromatic and chromatic aberrational correction across the field. The following data supports the relations among the optical elements 10, 12, 14, 16, 18 and other elements provided in lens assembly 1:

$$- 0.5 \; 4 < {F}_{1}^{′} / {F}_{10}^{′} < - 0.45$$

$$- 2.6 \; 0 < {F}_{10}^{′} / {F}_{12}^{′} < - 2.44$$

$$- 2.6 \; 0 < {F}_{10}^{′} / {F}_{14}^{′} < - 2.44$$

$$4.95 < {F}_{10}^{′} / {F}_{16}^{′} < 5.55$$

$$- 2.1 \; 0 < {F}_{10}^{′} / {F}_{18}^{′} < - 1.85$$

$$1.05 < {n}_{10} / {n}_{12} < 1.3$$

$$0.95 < {n}_{10} / {n}_{14} < 1.15$$

$$0.95 < {n}_{10} / {n}_{16} < 1.15$$

$$1. 05 < {n}_{10} / {n}_{18} < 1.3$$

$$0.35 < {V}_{10} / {V}_{12} < 0.45$$

$$0.9 < {V}_{10} / {V}_{14} < 1.1$$

$$0.9 < {V}_{10} / {V}_{16} < 1.1$$

$$0.35 < {V}_{10} / {V}_{18} < 0.45$$

$$1. 30 < {F}_{1}^{′} / {CSD}_{1} < 1.45$$

$$0.55 < {F}_{1}^{′} / {OAL}_{1} < 0.7$$

wherein: F′₁ is the focal length of the lens assembly 1 according to the present invention; F′₁₀, F′₁₂, F′₁₄, F′₁₆, and F′₁₈ are the focal lengths of the first optical element 10, the second optical element 12, the third optical element 14, the fourth optical element 16, and the fifth optical element 18 correspondingly; n₁₀, n₁₂, n₁₄, n₁₆ and n₁₈ are refractive indices for the first optical element 10, second optical element 12, third optical element 14, fourth optical element 16, and fifth optical element 18 correspondingly; V₁₀, V₁₂, V₁₄, V₁₆ and V₁₈ are the Abbe numbers for the first optical element 10, second optical element 12, third optical element 14, fourth optical element 16, and fifth optical element 18 correspondingly; OAL₁ is the overall length of the lens assembly 1; and CSD₁ is the distance from the cold shield 24 to the image plane 26 for the lens assembly 1.

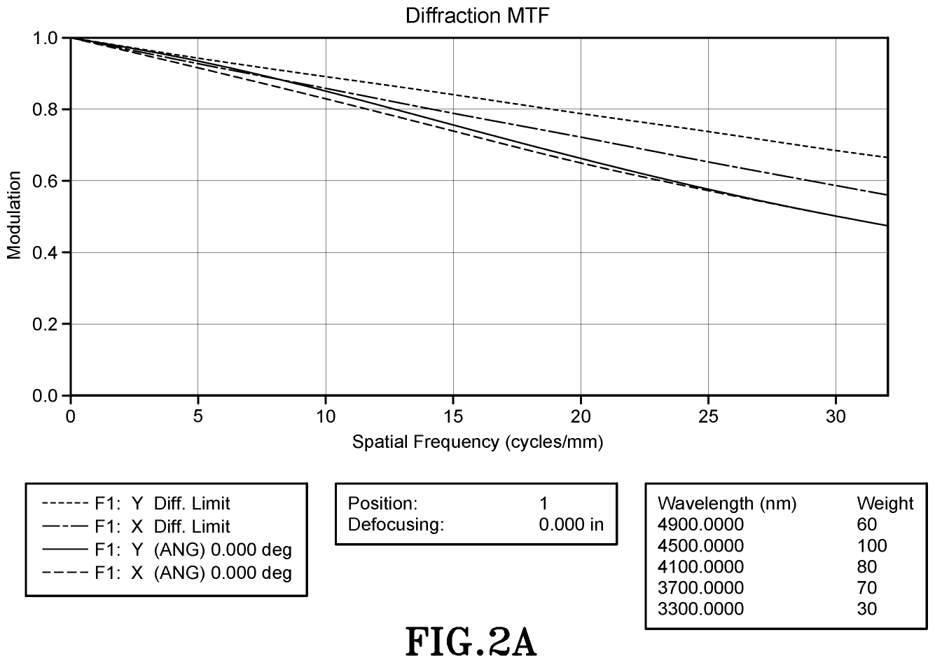

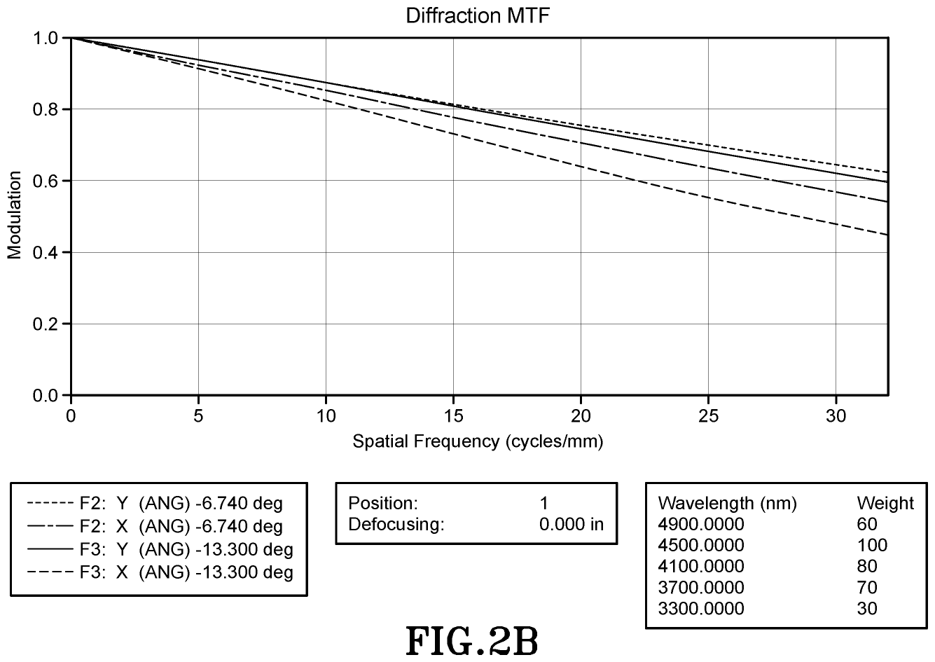

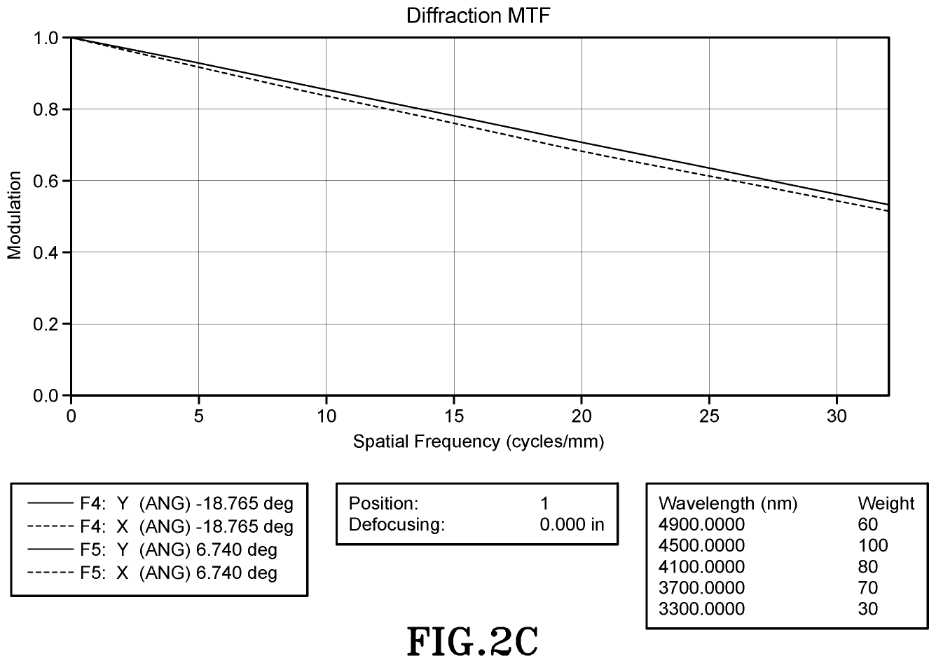

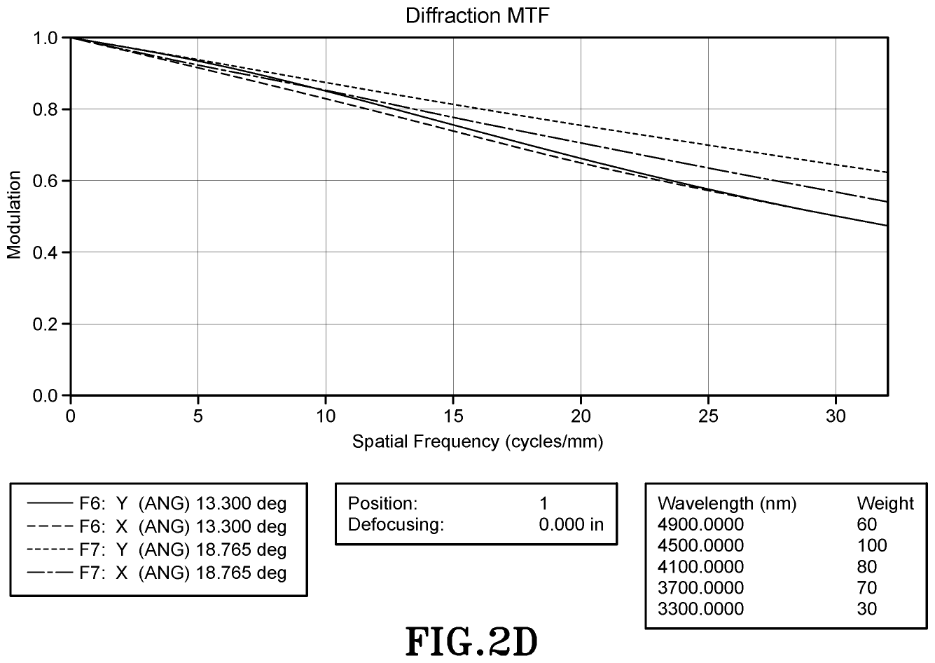

With reference to FIGS. 2A-5B, a series of graphs and tables are provided showing performance specifications of an exemplary lens assembly 1 as shown and described herein.

In particular reference to FIG. 2A-2D, FIG. 2A shows a first diffraction modulation transfer function (MTF) data graph indicating the lens assembly 1 being at half-Nyquist frequency of 31.25 lp/mm. FIG. 2B shows a second diffraction modulation transfer function (MTF) data graph indicating the lens assembly 1 being at half-Nyquist frequency of 31.25 lp/mm. FIG. 2C shows a third diffraction modulation transfer function (MTF) data graph indicating the lens assembly 1 being at half-Nyquist frequency of 31.25 lp/mm. FIG. 2D shows a fourth diffraction modulation transfer function (MTF) data graph indicating the lens assembly 1 being at half-Nyquist frequency of 31.25 lp/mm.

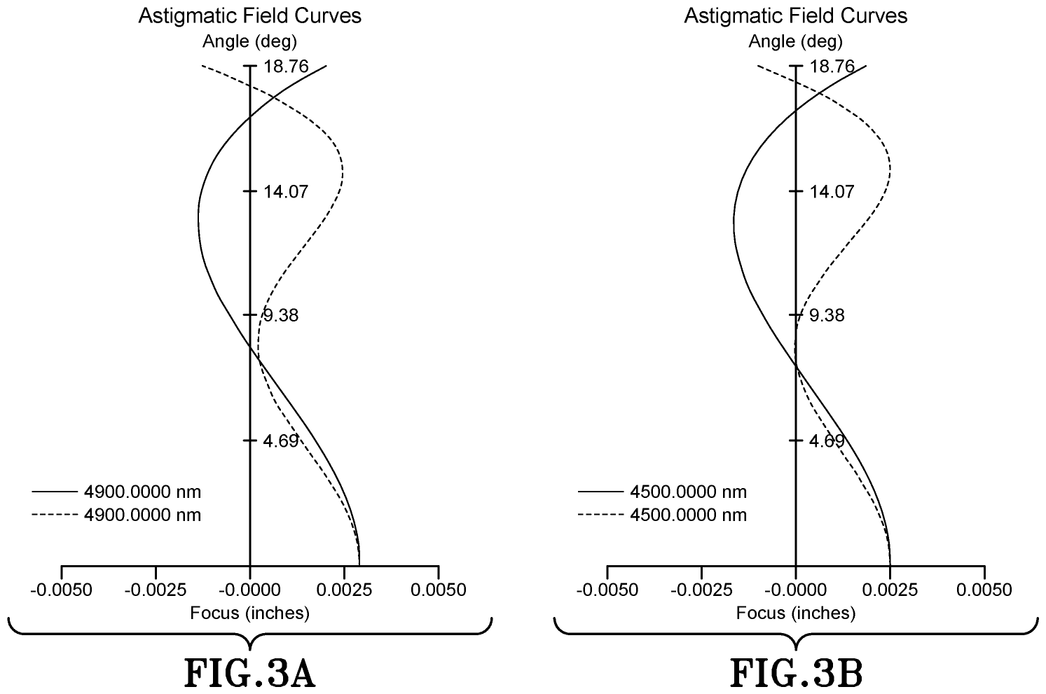

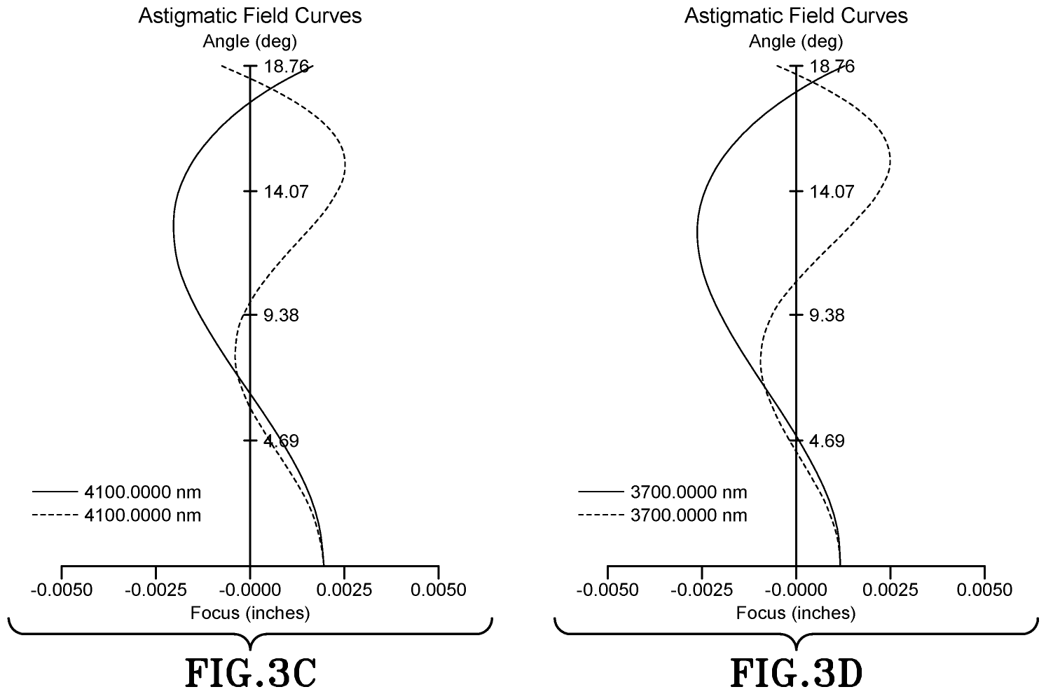

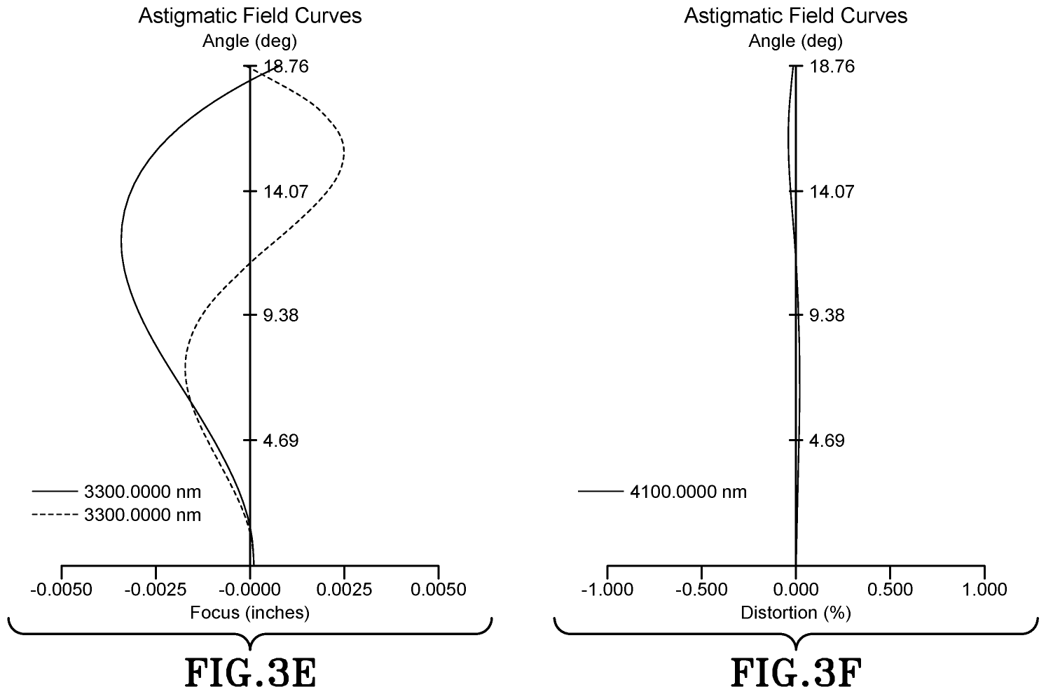

In particular reference to FIG. 3A-3F, FIG. 3A shows the field curves and/or chromatic astigmatic curves and distortion across the field of the lens assembly 1. FIGS. 3A-3F also shows the correction of tangential and sagittal astigmatisms of the lens assembly 1 in order to create an image plane flat where the distortion does not exceed 0.03% and the lens assembly 1 is entirely orthoscopic. FIG. 3A shows a first graph of astigmatism of the orthoscopic MWIR lens assembly shown in FIG. 1. FIG. 3B shows a second graph of astigmatism of the orthoscopic MWIR lens assembly shown in FIG. 1. FIG. 3C shows a third graph of astigmatism of the orthoscopic MWIR lens assembly shown in FIG. 1. FIG. 3D shows a fourth graph of astigmatism of the orthoscopic MWIR lens assembly shown in FIG. 1. FIG. 3E shows a fifth graph of astigmatism of the orthoscopic MWIR lens assembly shown in FIG. 1. FIG. 3F is a graph of distortion of the orthoscopic MWIR lens assembly shown in FIG. 1.

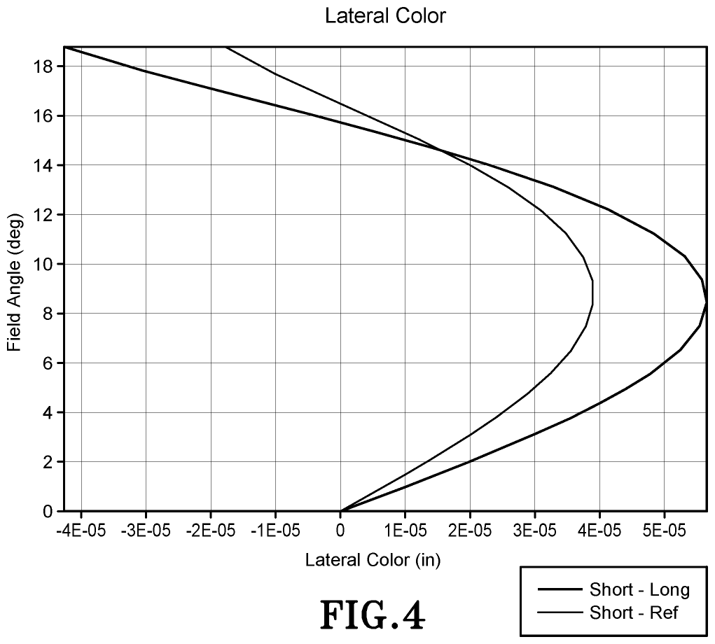

In particular reference to FIG. 4, FIG. 4 shows that the lateral color is corrected across the field of view for the entire spectrum. More particularly, the lateral color is corrected across the field via the lens assembly 1 where the lens assembly 1 is apochromatic.

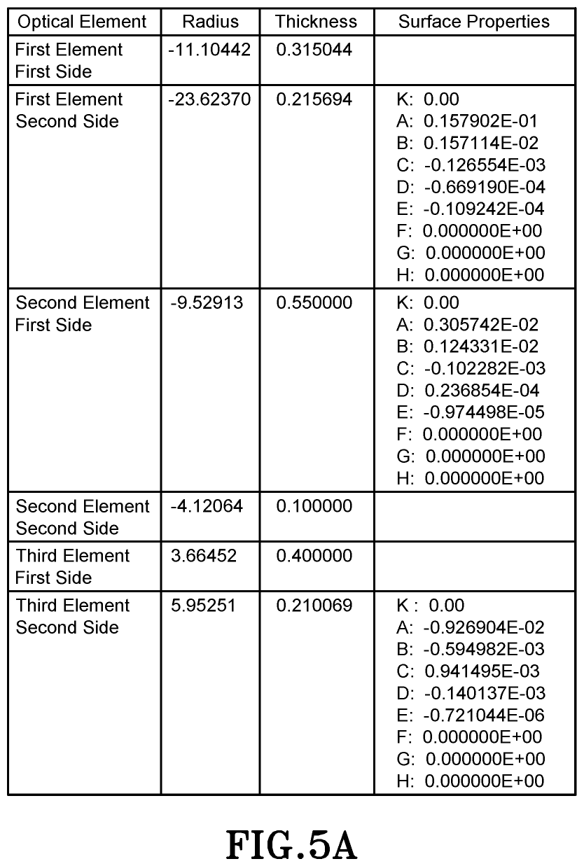

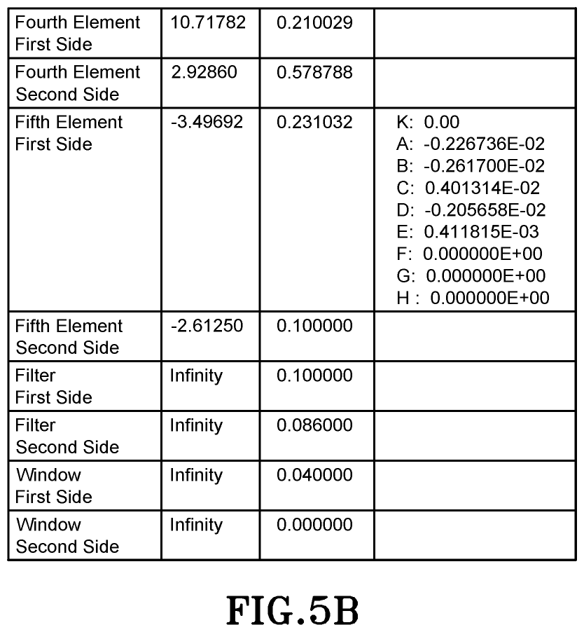

In particular reference to FIGS. 5A and 5B, FIGS. 5A and 5B show a table listing properties of the first optical element 10, the second optical element 12, the third optical element 14, the fourth optical element 16, and the fifth optical element 18 and other components of the lens assembly 1 described and illustrated herein. Such data provided in FIGS. 5A and 5B is derived from the following equation(s) and information for forming an asphere surface:

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20}$$

$$r = \sqrt{{x}^{2} + {y}^{2}}$$

where z is the sag of the surface parallel to the z-axis, c is the curvature at the pole of the surface (CUY), k is the conic constant (K), A is the fourth deformation coefficient, B is the sixth deformation coefficient, C is the eighth deformation coefficient, D is the tenth deformation coefficient, E is the twelfth deformation coefficient, F is the fourteenth deformation coefficient, G is the sixteenth deformation coefficient, H is the eighteenth deformation coefficient, and J is the twentieth deformation coefficient, and r is the radial distance where A=B=C=D=E=F=G=H=J=0 yields a pure conic surface. In one instance where k=0, the conic constant k defines a sphere. In another instance where −1<k<0, the conic constant k defines an ellipsoid with major axis on the optical axis (prolate spheroid). In another instance where k=−1, the conic constant k defines a paraboloid. In another instance where k<−1, the conic constant k defines a hyperboloid. In another instance where k=−e² (e is the eccentricity) and k>0, conic constant k defines a oblate spheroid (not a conic section) where the surface is generated by rotating an ellipse about its minor axis and

$$k = \frac{{e}^{2}}{( 1 - {e}^{2} )}$$

in which e is the eccentricity of the generating ellipse in the previous equation. In another instance, an even-ordered polynomial is represented by setting k=−1 and using c/2, A, B, and the remaining deformation coefficients described above as the even-order coefficients.

Having now described the elements and components of lens assembly 1, the operation and use of lens assembly 1 will now be discussed.

Lens assembly 1 may be utilized as a MWIR imaging lens for airborne operations including, but not limited to, airborne sensor platforms for a pre-objective configuration scanning mode, or other similar engagements, where a scan mirror is located in front of the lens assembly 1. As previously discussed above, the lens assembly 1 may have a F # of approximately 2.2 with an angular full field of view of 37.5 degrees. Lens assembly 1 may be further corrected from monochromatic aberrations along with axial and lateral chromatic aberrations over the MWIR wavelength range between 5000 nanometers to 3300 nanometers. According to one aspect, the focal length of the lens assembly 1 may be 3.56 inches (as denoted by D2 in FIG. 1) and the overall length of the lens assembly 1 may be 5.8 inches (as denoted by D3 in FIG. 1).

As employed, lens assembly 1 operates such that light may enter lens assembly 1 through the first optical element 10 and passes through the remaining optical elements 12, 14, 16, 18 and the first and second surfaces thereof, respectively. In doing so, the image may be focused on the image plane detector 26 as temperature and other conditions change the shapes and positions of first through fifth optical elements 10, 12, 14, 16, 18 may likewise change and/or fluctuate. This may further cause the changes to the focusing and positions of the images. As discussed above, the optical powers of the optical elements 10, 12, 14, 16, 18 along with shapes, refractive indices, and specific materials are selected such that the lens assembly 1 is both apochromatic and orthoscopic. Moreover, the combination of fast F # and a long focal length described herein supports a lens configuration of MWIR focal planes for higher resolution of aerial reconnaissance and surveillance.

Once light passes through the optical elements 10, 12, 14, 16, 18 of lens assembly 1, the light may then be directed to the image plane detector 26 where the light is detected and processed to generate an image according to the desired objective of the implementation of lens assembly 1. For example, where lens assembly 1 is employed in a pre-objective configuration scanning mode, the image plane detector 26 (including processor(s) in communication therewith) may detect and generate an image of the remote object formed on a focal plane, which may constitute high resolution via a charge coupled device (or CCD) or complementary metal oxide semiconductor (or CMOS).

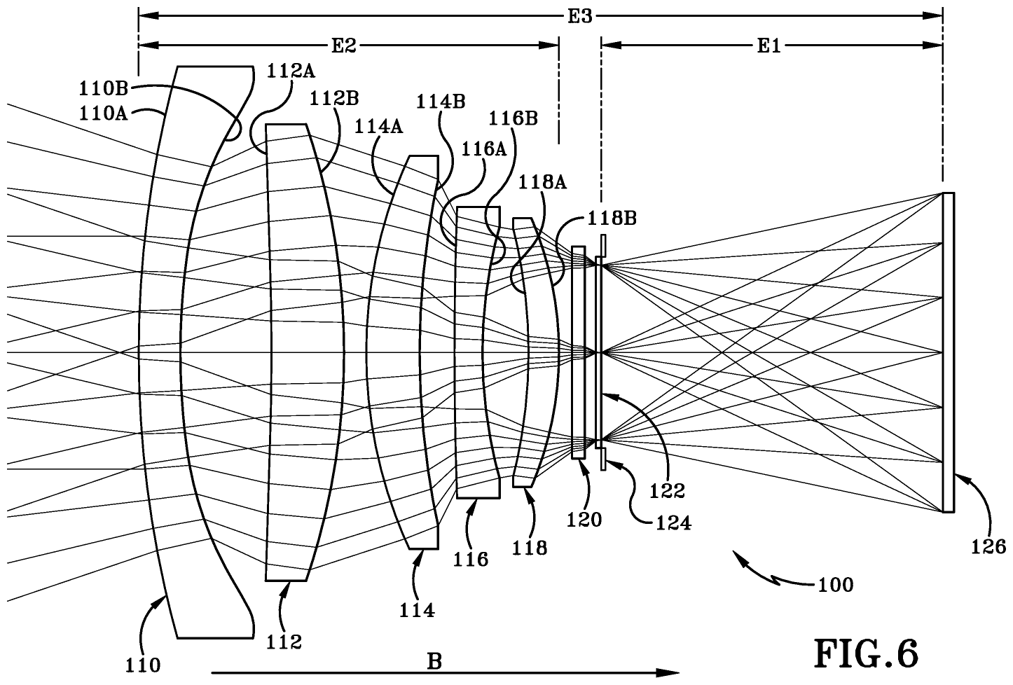

As illustrated in FIG. 6, another MWIR imaging lens assembly is generally referenced at 100. Generally, lens assembly 100 may include several optical elements, namely, a first optical element 110, a second optical element 112, a third optical element 114, a fourth optical element 116, and a fifth optical element 118. As described in more detail below, the second optical element 112, the third optical element 114, and the fifth optical element 118 form a first set of optical elements of the lens assembly 100, and the first optical element 110 and the fourth optical element 116 form a second set of optical elements of the lens assembly 100.

Generally, the lens assembly 100 may be an apochromatic and orthoscopic MWIR imaging lens operable with the wide MWIR spectrum ranging from approximately 3000 nanometers to approximately 5000 nanometers. More particularly, the lens assembly 100 may be an apochromatic and orthoscopic MWIR imaging lens operable with the wide MWIR spectrum ranging from approximately 3300 nanometers to approximately 5000 nanometers. Specifically, the lens assembly 100 may be an apochromatic and orthoscopic MWIR imaging lens operable with the wide MWIR spectrum ranging from approximately 3300 nanometers to approximately 4900 nanometers. Additionally, the lens assembly 100 includes the following specifications and/or features regarding a F #, an instantaneous field of view measurement (IFOV), a focal length (EFL), and an overall length (OAL):

| F# | 2.0 | |
|---|---|---|
| Pixel Size | 8 | μm |
| IFOV | 88.5 | μrad |
| EFL | 3.56 | inches |
| Distortion | <1% | |
| MTF | >0.4 cross field, at half-Nyquist 31.25 lp/mm | |
| OAL | 6.1 | inches |

As best seen in FIG. 6, the first optical element 110 through the fifth optical element 118 may be determined by their position within lens assembly 100 based on the order in which each optical element may encounter light entering through the lens assembly 100. Specifically, as indicated by arrow B in FIG. 6, light may initially enter through the first optical element 110 and then pass through the remaining second optical element 112 through the fifth optical element 118. Accordingly, each element may be numbered relative to their position in this path. However, it will be understood than any numbering convention may be used, as desired. Although first optical element 110 through the fifth optical element 118 may be constructed of any suitable material, it is contemplated that each optical element 110, 112, 114, 116, 118 may be constructed and/or formed of any suitable material. In the current aspect, it is contemplated that each optimal element 110, 112, 114, 116, 118 will be formed of one of two types of optical glass material found to impart the desired properties into the lens assembly 100. Accordingly, as detailed below, each optical element 110, 112, 114, 116, 118 may be formed of commercially available Germanium material or Silicon material. Moreover, at least one surface of at least one optical element 110, 112, 114, 116, 118 may be shaped to a specific orientation and may be one of spherical and aspherical for various reasons, including allowing correction of monochromatic aberrations along with correction of axial and lateral chromatic aberrations and distortions; such configurations of these optical elements 110, 112, 114, 116, 118 are described in further detail below.

As best seen in FIG. 6, the first optical element 110 of the lens assembly 100 is the initial optical element in the order of the lens assembly 100. Based on the order of the lens assembly 100, the first optical element 110 is configured to initially receive light emitted from a remote object located at a distance away from the lens assembly 100. The first optical element 110 is also configured to direct and diverge the light received from the remote object onto the second optical element 112.

As best seen in FIG. 6, the first optical element 110 includes a first surface 110A that faces towards the remote object located away from the lens assembly 100. The first optical element 110 also includes a second surface 110B that faces in an opposite direction of the first surface 110A and faces towards the second optical element 112. According to one aspect, the first optical element 110 is made in a form of a negative meniscus where the second surface 110B is a concave surface that faces towards an image plane detector of lens assembly 100, and the first optical element 110 is also configured with a negative optical power. The first surface 110A of the first optical element 110 is formed spherically. The second surface 110B of the first optical element 110 is also formed aspherical in order to correct for the titled wide beam spherical aberration and coma across the field. Moreover, the first optical element 110 is made of Germanium material.

As best seen in FIG. 6, the second optical element 112 of the lens assembly 100 is the second element in the order of the lens assembly 100. Based on the order of the lens assembly 100, the second optical element 112 is configured to receive the diverged light emitted from the first optical element 110. The second optical element 112 is also configured to converge the light from the first optical element 110 and to direct the diverged light received from the second optical element 112 onto the third optical element 114.

As best seen in FIG. 6, the second optical element 112 includes a first surface 112A that faces towards the first optical element 110 of the lens assembly 1 and/or the remote object. The second optical element 112 also includes a second surface 112B that faces in an opposite direction of the first surface 112A and faces towards the third optical element 114. According to one aspect, the second optical element 112 is made in a form of a positive meniscus where the first surface 112A is a concave surface that faces towards the remote object, and the second optical element 112 is also configured with a positive optical power. The first surface 112A of the second optical element 112 is formed aspherical in order to correct for high order astigmatism and residual coma. The second surface 112B of the second optical element 112 is also formed spherically. Moreover, the second optical element 112 is made of Silicon material.

As best seen in FIG. 6, the third optical element 114 of the lens assembly 100 is the third element in the order of the lens assembly 100. Based on the order of the lens assembly 100, the third optical element 114 is configured to receive and further converge the converged light directed from the second optical element 112. The third optical element 114 is also configured to further direct the converged light received from the second optical element 112 onto the fourth optical element 116.

As best seen in FIG. 6, the third optical element 114 includes a first surface 114A that faces towards the second optical element 112 of the lens assembly 100 and/or the remote object. The third optical element 114 also includes a second surface 114B that faces in an opposite direction of the first surface 114A and faces towards the fourth optical element 116. According to one aspect, the third optical element 114 is made in a form of a positive meniscus where the second surface 114B is a concave surface that faces towards an image plane detector of the lens assembly 100, which is described in more detail below. The first surface 114A of the third optical element 14 is formed spherically. The second surface 141B of the third optical element 114 is also formed aspherical in order to correct for high order astigmatism and coma correction. Moreover, the third optical element 114 is made of Germanium material.

As best seen in FIG. 6, the fourth optical element 116 of the lens assembly 100 is the fourth element in the order of the lens assembly 100. Based on the order of the lens assembly 100, the fourth optical element 116 is configured to receive and diverge the light directed from the third optical element 114. The fourth optical element 116 is also configured to direct the converged light received from the third optical element 114 onto the fifth optical element 118.

As best seen in FIG. 6, the fourth optical element 116 includes a first surface 116A that faces towards the third optical element 114 of the lens assembly 100 and/or the remote object. The fourth optical element 116 also includes a second surface 116B that faces in an opposite direction of the first surface 116A and faces towards the fifth optical element 118. According to one aspect, the fourth optical element 116 is made in a form of a negative meniscus where the first surface 116A is a concave surface that faces towards the remote object positioned away from the lens assembly 100. Moreover, the fourth optical element 116 is made of Germanium material.

As best seen in FIG. 6, the fifth optical element 118 of the lens assembly 100 is the fifth element in order of the lens assembly 100. Based on the order of the lens assembly 100, the fifth optical element 118 is configured to receive the diverged light directed from the fourth optical element 116. The fifth optical element 118 is also configured to direct the diverged light received from the fourth optical element 116 onto a filter of the lens assembly 100, which is described in more detail below.

As best seen in FIG. 6, the fifth optical element 118 includes a first surface 118A that faces towards the fourth optical element 116 of the lens assembly 100 and/or the remote object. The fifth optical element 118 also includes a second surface 118B that faces in an opposite direction of the first surface 118A and faces towards the filter of the lens assembly 100. According to one aspect, the fifth optical element 118 is made in a form of a positive meniscus where the first surface 118A is a concave surface that faces towards the remote object positioned away from the lens assembly 100. The first surface 118A of the fifth optical element 118 is formed aspherical in order to correct for sagittal astigmatism. The second surface of the fifth optical element 118B is also formed spherically. Moreover, the fifth optical element 118 is made of Silicon material.

The optical powers and shape of each of the first optical element 110, the second optical element 112, the third optical element 114, the fourth optical element 116, and the fifth optical element 118 may be selected, along with the choice of materials and special usage of high order aspherical surfaces, to enable correction of monochromatic aberrations along with correction of axial and lateral chromatic aberrations and distortion. As such, the optical powers, the shapes, the refractive indices, and the dispersions of materials of the optical elements 110, 112, 114, 116, 118 are selected such that the lens assembly 100 is both apochromatic and orthoscopic. The lens assembly 100 described herein is configured to be used in a scanning airborne system of an aircraft in a configuration where a scan mirror is loaded forwardly of the lens assembly 100, specifically forward of the first optical element 110 of the lens assembly 100. Moreover, the lens distortion of lens assembly 1 is less than 0.1% in which the lens assembly 100 is corrected for both monochromatic and chromatic aberrations over the wavelength range from about 5000 nm to about 3300 nm.

The optical powers and shape of each of the first optical element 110, the second optical element 112, the third optical element 114, the fourth optical element 116, and the fifth optical element 118 may be selected, along with the glass refractive indices and dispersion, to achieve orthoscopy, a flat image plane, and to provide monochromatic and chromatic correction of lens assembly 100 with high resolution. In this present aspect, the lens assembly 100 is configured with a wide angle field of view of about 37.5 degree along with achieving a F #2 value while having a desired distance of about 2.6 inches measured from the cold shield 124 to the image plane detector 126. In this present aspect, the lens assembly 100 is also compact in structural configuration and is configured to utilize one or both of the only two optical materials, particularly Germanium and Silicon.

As best seen in FIG. 6, the lens assembly 100 also includes filter 120. The filter 120 is the sixth element in order of the lens assembly 100 positioned longitudinally behind and/or positioned adjacent to the fifth optical element 118. The lens assembly 100 also includes Dewar window 122. The Dewar window 122 is the seventh element in order of the lens assembly 100 positioned longitudinally behind and/or positioned adjacent to the filter 120.

As best seen in FIG. 6, the lens assembly 100 also includes cold shield 124. The cold shield 124 is the eighth element in order of the lens assembly 100 positioned longitudinally behind the fifth optical element 118 and positioned longitudinally behind and/or positioned adjacent to the Dewar window 122. The cold shield 124 is also positioned ahead of and/or position forward of an image plane detector 126 of the lens assembly 100. In one instance, the cold shield 124 is approximately one hundred percent efficient and is the aperture stop for lens assembly 100.

As best seen in FIG. 6, a first distance E1 is measured from the cold shield 124 to the image plane detector 126. In one example, the first distance E1 that is measured from the cold shield 124 to the image plane detector 126 is about 2.6 inches. As best seen in FIG. 6, a second distance E2 is measured from the first optical element 110 to the fifth optical element 118 in which the second distance E2 defines the focal length of the lens assembly 100. In one example, the second distance E2 that is measured from the first optical element 110 to the fifth optical element 118 is about 3.56 inches which defines the focal length of the lens assembly 100. As best seen in FIG. 6, a third distance E3 is measured from the first optical element 110 to the image plane detector 126 in which the third distance E3 defines the entire length of the lens assembly 100. In one example, the third distance E3 that is measured from the first optical element 110 to the image plane detector 126 is about 6.1 inches which defines the entire length of the lens assembly 100.

With continued referenced to FIG. 6, the first optical element 110, the second optical element 112, the third optical element 114, the fourth optical element 116, and the fifth optical element 118 are numbered and arranged such that the first optical element 110 is positioned closest to the remote object in the far field while the fifth optical element 118 is positioned closest to and/or adjacent to the filter 120, the Dewar window 122, and the cold shield 124. Accordingly, it will be understood that these optical elements 110, 112, 114, 116, 118 are numbered in order from the remote object to the to the filter 120, the Dewar window 122, the cold shield 124, and the image plane detector 126 and may be numbered in any other suitable order or position. Generally, lens assembly 100 may include a housing or similar structure containing each of the component described herein, as dictated by the desired implementation. Such housing is not shown in FIG. 6 but may be included in any suitable position, shape, form, and/or with any desired features, as dictated by the desired implementation.

Filter 120 may be a standard and/or commercially available filter as desired according to a specific implementation of lens assembly 100. Dewar window 122 may also be a standard and/or commercially available Dewar window as desired according to a specific implementation of lens assembly 100. Cold shield 124 may also be a standard and/or commercially available cold shield as desired according to a specific implementation of lens assembly 100. Image plane detector 126 may also be a standard and/or commercially available image plane detector as desired according to a specific implementation of lens assembly 100.

For lens assembly 100, according to one aspect, the following relations among the optical powers and the materials that form the optical elements 110, 112, 114, 116, 118 have been found to achieve orthoscopy, flat field and monochromatic and chromatic aberrational correction across the field. The following data supports the relations among the optical elements 110, 112, 114, 116, 118 and other elements provided in lens assembly 100:

$$- 0.5 \; 5 < {F}_{100}^{′} / {F}_{110}^{′} < - 0.48$$

$$- 2.4 \; 2 < {F}_{110}^{′} / {F}_{112}^{′} < - 2.34$$

$$- 2.3 \; 4 < {F}_{110}^{′} / {F}_{114}^{′} < - 2.20$$

$$5.2 < {F}_{110}^{′} / {F}_{116}^{′} < 5.45$$

$$- 2.5 \; 5 < {F}_{110}^{′} / {F}_{118}^{′} < - 2.36$$

$$1.05 < {n}_{110} / {n}_{112} < 1.15$$

$$0.9 < {n}_{110} / {n}_{114} < 1.11$$

$$0.9 < {n}_{110} / {n}_{116} < 1.11$$

$$1.05 < {n}_{110} / {n}_{118} < 1.15$$

$$0.37 < {V}_{110} / {V}_{112} < 0.43$$

$$0.95 < {V}_{110} / {V}_{114} < 1.1$$

$$0.95 < {V}_{110} / {V}_{116} < 1.1$$

$$0.37 < {V}_{110} / {V}_{118} < 0.43$$

$$1.35 < {F}_{100}^{′} / {CSD}_{100} < 1.5$$

$$0.55 < {F}_{100}^{′} / {OAL}_{100} < 0.65$$

wherein: F′₁₀₀ is the focal length of the lens assembly 100 according to the present invention; F′₁₁₀, F′₁₁₂, F′₁₁₄, F′₁₁₆, and F′₁₁₈ are the focal lengths of the first optical element 110, the second optical element 112, the third optical element 114, the fourth optical element 116, and the fifth optical element 118 correspondingly; n₁₁₀, n₁₁₂, n₁₁₄, n₁₁₆ and n₁₁₈ are refractive indices for the first optical element 110, second optical element 112, third optical element 114, fourth optical element 116, and fifth optical element 118 correspondingly; V₁₁₀, V₁₁₂, V₁₁₄, V₁₁₆ and V₁₁₈ are the Abbe numbers for the first optical element 110, second optical element 112, third optical element 114, fourth optical element 116, and fifth optical element 118 correspondingly; OAL₁₀₀ is the overall length of the lens assembly 100; and CSD₁₀₀ is the distance from the cold shield 124 to the image plane 126 for the lens assembly 100.

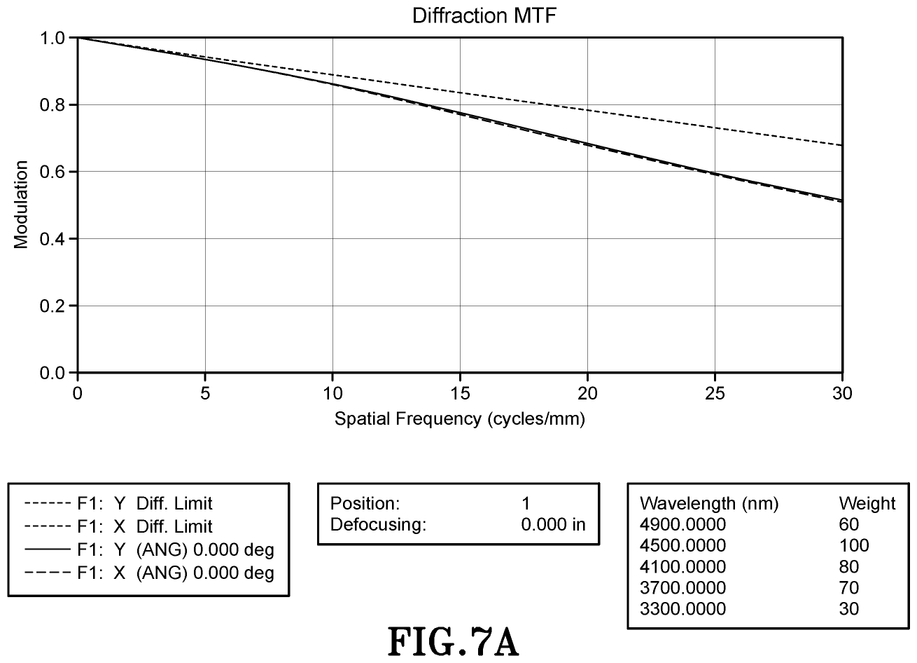

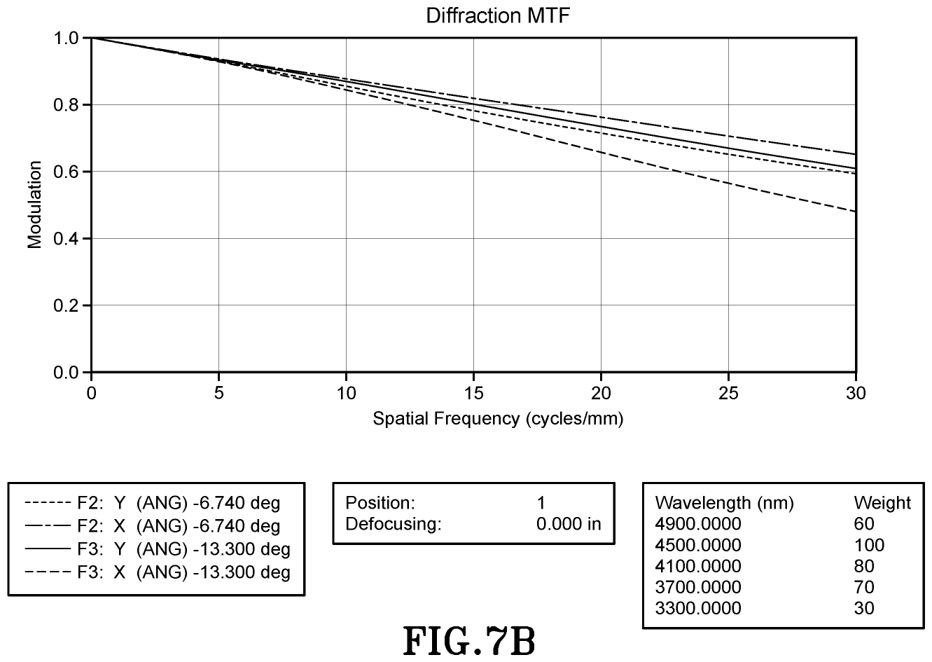

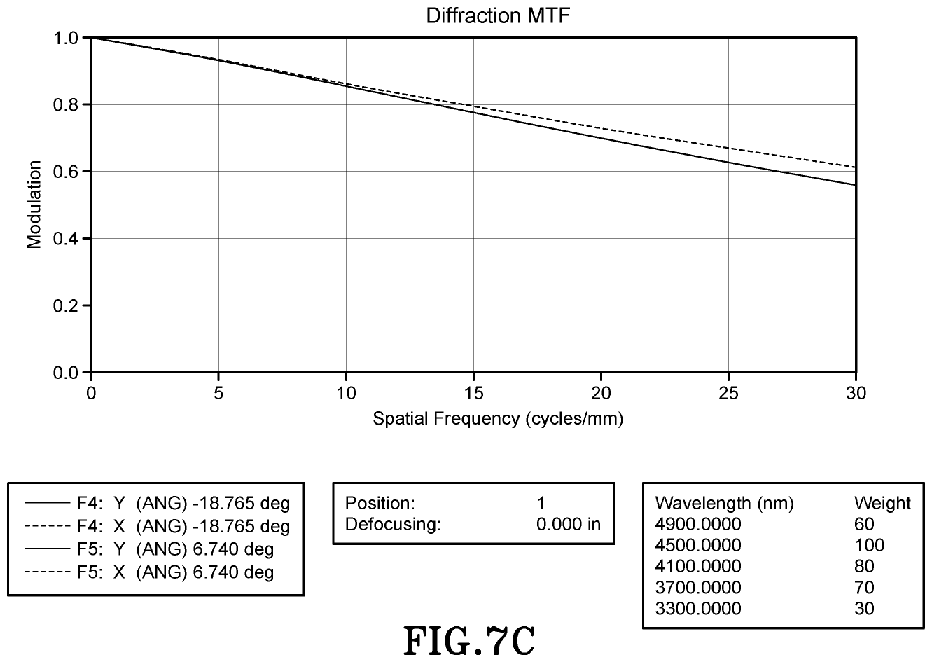

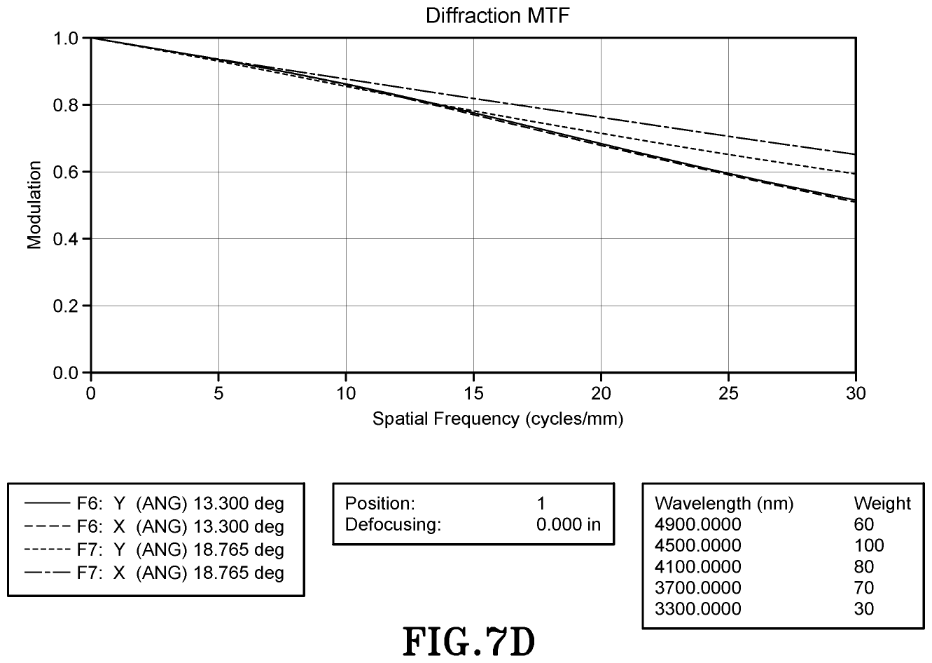

With reference to FIGS. 7A-10B, a series of graphs and tables are provided showing performance specifications of an exemplary lens assembly 100 as shown and described herein.

In particular reference to FIG. 7A, FIG. 7A shows a first diffraction modulation transfer function (MTF) data graph indicating the lens assembly 100 being at half-Nyquist frequency of 31.25 lp/mm. FIG. 7B shows a second diffraction modulation transfer function (MTF) data graph indicating the lens assembly 100 being at half-Nyquist frequency of 31.25 lp/mm. FIG. 7C shows a third diffraction modulation transfer function (MTF) data graph indicating the lens assembly 100 being at half-Nyquist frequency of 31.25 lp/mm. FIG. 7D shows a fourth diffraction modulation transfer function (MTF) data graph indicating the lens assembly 100 being at half-Nyquist frequency of 31.25 lp/mm.

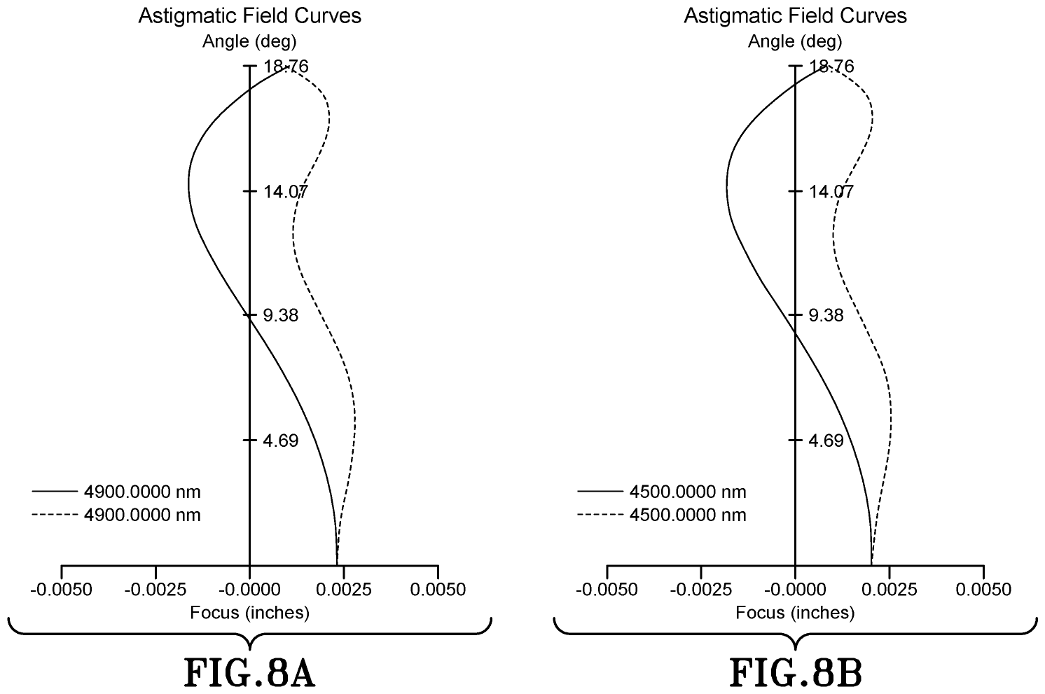

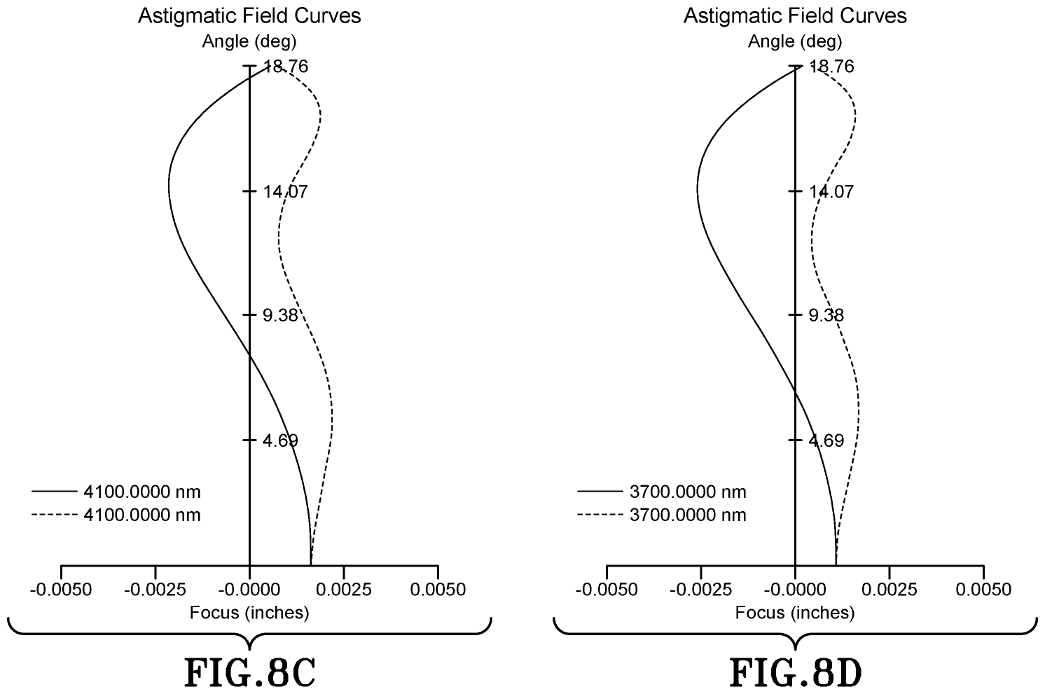

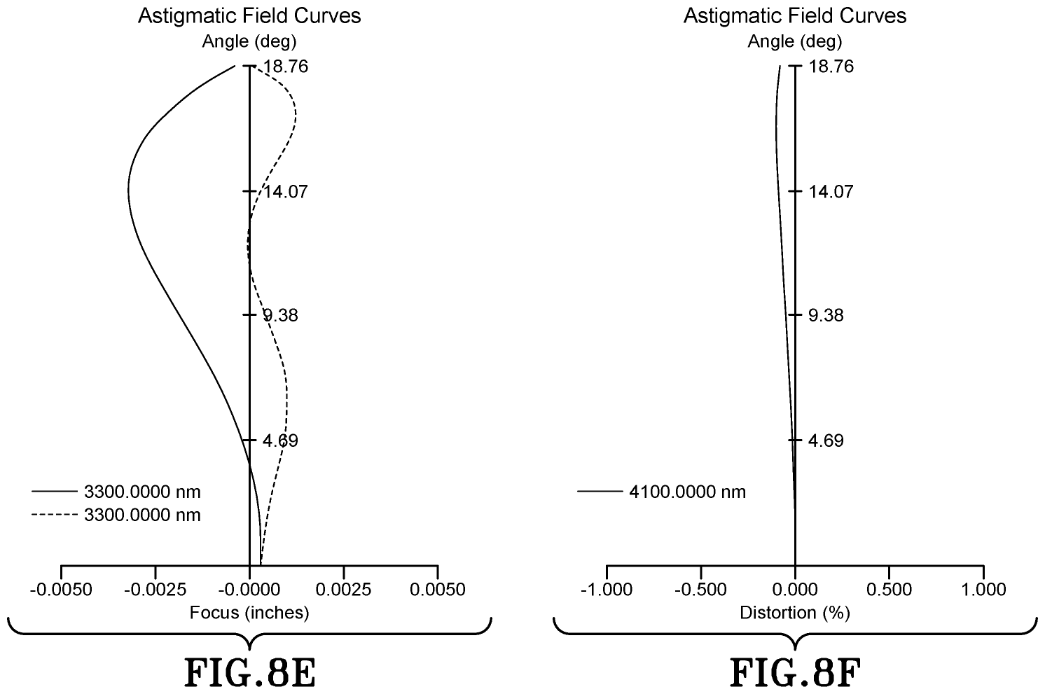

In particular reference to FIGS. 8A-8F, FIGS. 8A-8F shows the field curves and/or chromatic astigmatic curves and distortion across the field of the lens assembly 100. FIGS. 8A-8F also shows the correction of tangential and sagittal astigmatisms of the lens assembly 100 in order to create an image plane flat where the distortion does not exceed 0.1% and the lens assembly 100 is entirely orthoscopic. FIG. 8A is a first graph of astigmatism of the orthoscopic MWIR lens assembly shown in FIG. 6. FIG. 8B is a second graph of astigmatism of the orthoscopic MWIR lens assembly shown in FIG. 6. FIG. 8C is a third graph of astigmatism of the orthoscopic MWIR lens assembly shown in FIG. 6. FIG. 8D is a fourth graph of astigmatism of the orthoscopic MWIR lens assembly shown in FIG. 6. FIG. 8E is a fifth graph of astigmatism of the orthoscopic MWIR lens assembly shown in FIG. 6. FIG. 8F is a graph of distortion of the orthoscopic MWIR lens assembly shown in FIG. 6

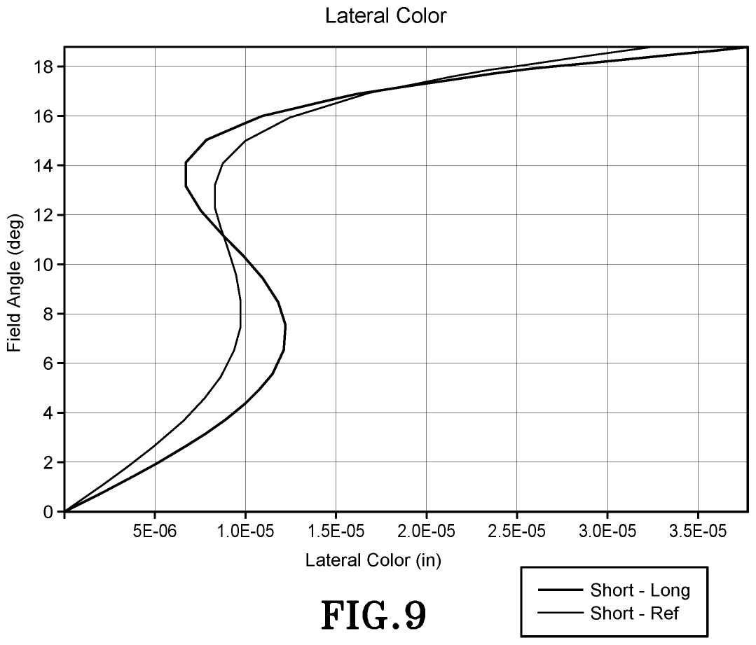

In particular reference to FIG. 9, FIG. 9 shows that the lateral color is corrected across the field of view for the entire spectrum. More particularly, the lateral color is corrected across the field via the lens assembly 100 where the lens assembly 100 is apochromatic.

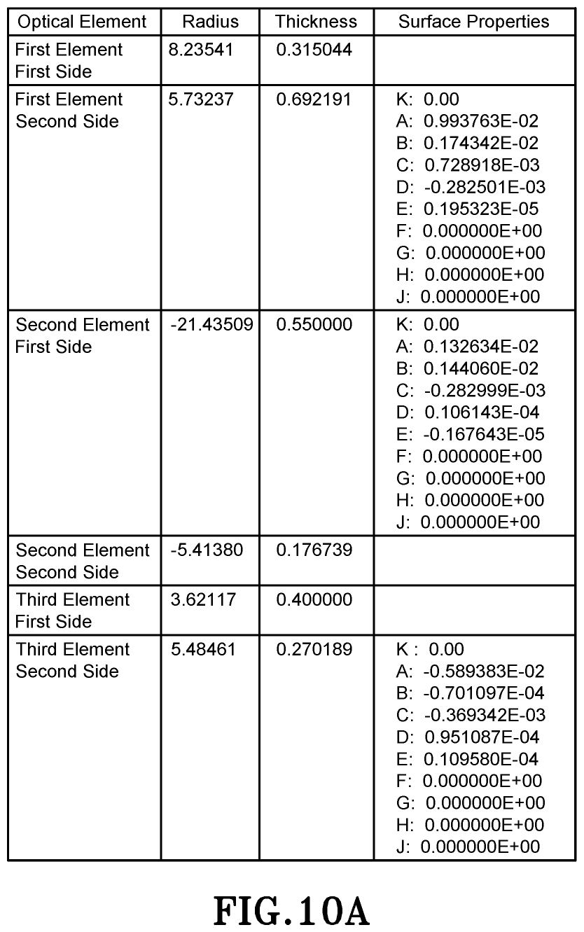

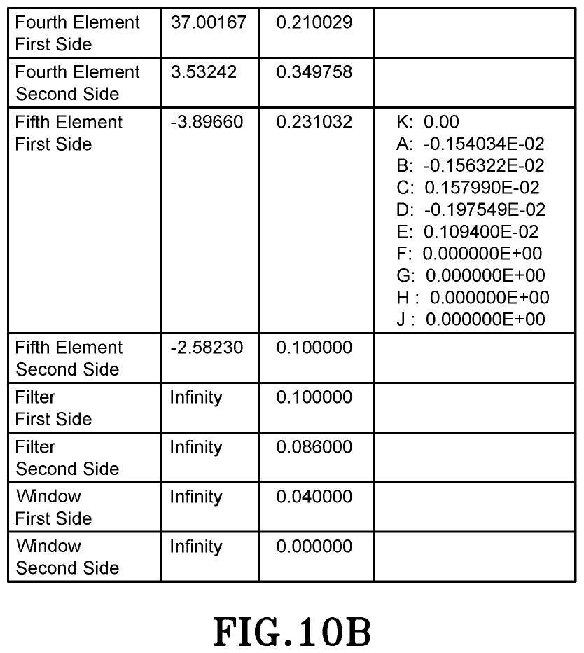

In particular reference to FIGS. 10A-10B, FIGS. 10A-10B shows a table listing properties of the first optical element 110, the second optical element 112, the third optical element 114, the fourth optical element 116, and the fifth optical element 118 and other components of the lens assembly 100 described and illustrated herein. Such data provided in FIGS. 10A and 10B is derived from the following equation(s) and information for forming an asphere surface:

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20}$$

$$r = \sqrt{{x}^{2} + {y}^{2}}$$

where z is the sag of the surface parallel to the z-axis, c is the curvature at the pole of the surface (CUY), k is the conic constant (K), A is the fourth deformation coefficient, B is the sixth deformation coefficient, C is the eighth deformation coefficient, D is the tenth deformation coefficient, E is the twelfth deformation coefficient, F is the fourteenth deformation coefficient, G is the sixteenth deformation coefficient, H is the eighteenth deformation coefficient, and J is the twentieth deformation coefficient, and r is the radial distance where A=B=C=D=E=F=G=H=J=0 yields a pure conic surface. In one instance where k=0, the conic constant k defines a sphere. In another instance where −1<k<0, the conic constant k defines an ellipsoid with major axis on the optical axis (prolate spheroid). In another instance where k=−1, the conic constant k defines a paraboloid. In another instance where k<−1, the conic constant k defines a hyperboloid. In another instance where k=−e² (e is the eccentricity) and k>0, conic constant k defines a oblate spheroid (not a conic section) where the surface is generated by rotating an ellipse about its minor axis and

$$k = \frac{{e}^{2}}{( 1 - {e}^{2} )}$$

in which e is the eccentricity of the generating ellipse in the previous equation. In another instance, an even-ordered polynomial is represented by setting k=−1 and using c/2, A, B, and the remaining deformation coefficients described above as the even-order coefficients.

Having now described the elements and components of lens assembly 100, the operation and use of lens assembly 100 will now be discussed.

Lens assembly 100 may be utilized as a MWIR imaging lens for airborne operations including, but not limited to, airborne sensor platforms for a pre-objective configuration scanning mode, or other similar engagements, where a scan mirror is located in front of the lens assembly 100. As previously discussed above, the lens assembly 100 may have a F # of approximately 2 with an angular full field of view of 37.5 degrees. Lens assembly 100 may be further corrected from monochromatic aberrations along with axial and lateral chromatic aberrations over the MWIR wavelength range between 5000 nanometers to 3300 nanometers. According to one aspect, the focal length of the lens assembly 100 may be 3.56 inches (as denoted by E2 in FIG. 6) and the overall length of the lens assembly 100 may be 6.1 inches (as denoted by E3 in FIG. 6).

As employed, lens assembly 100 operate similar to other common MWIR lenses, namely, light may enter lens assembly 100 through the first optical element 110 and passes through the remaining optical elements 112, 114, 116, 118 and the first and second surfaces thereof, respectively. In doing so, the image may be focused on the image plane detector 126 as temperature and other conditions change the shapes and positions of first through fifth optical elements 110, 112, 114, 116, 118 may likewise change and/or fluctuate. This may further cause the changes to the focusing and positions of the images. As discussed above, the optical powers of the optical elements 110, 112, 114, 116, 118 along with shapes, refractive indices, and specific materials are selected such that the lens assembly 100 is both apochromatic and orthoscopic. Moreover, the combination of fast F # and a long focal length described herein supports a lens configuration of MWIR focal planes for higher resolution of aerial reconnaissance and surveillance.

Once light passes through the optical elements 110, 112, 114, 116, 118 of lens assembly 100, the light may then be directed to the image plane detector 26 where the light is detected and processed to generate an image according to the desired objective of the implementation of lens assembly 1. For example, where lens assembly 100 is employed in a pre-objective configuration scanning mode, the image plane detector 126 (including processor(s) in communication therewith) may detect and generate an image of the remote object formed on a focal plane, which may constitute high resolution via a charge coupled device (or CCD) or a complementary metal oxide semiconductor (or CMOS).

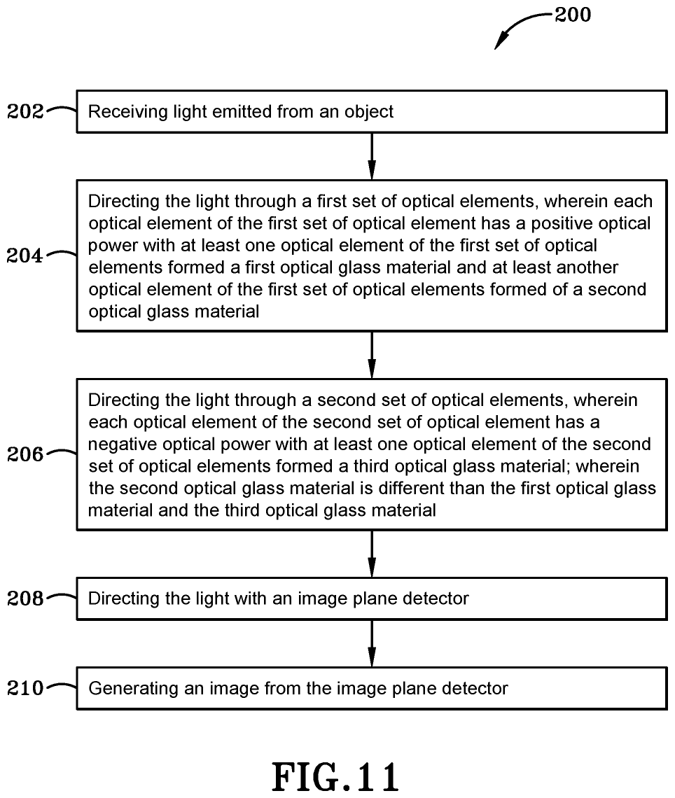

FIG. 11 illustrates a method flowchart generally referred as 200. An initial step 202 of method 200 includes receiving light emitted from an object. Another step 204 of method 200 includes directing the light through a first set of optical elements, wherein each optical element of the first set of optical elements has a positive optical power with at least one optical element of the first set of optical elements formed a first optical glass material and at least another optical element of the first set of optical elements formed of a second optical glass material. Another step 206 of method 200 includes directing the light through a second set of optical elements, wherein each optical element of the second set of optical elements has a negative optical power with at least one optical element of the second set of optical elements formed a third optical glass material; wherein the second optical glass material is different than the first optical glass material and the third optical glass material. Another step 208 of method 200 includes directing the light with an image plane detector. Another step 210 of method 200 includes generating an image from the image plane detector.

In other exemplary embodiments, method 200 may include additional steps and/or optional steps. Optional steps may include that the steps of directing the light through the first set of optical elements and directing the light through the second set of optical elements further comprises: directing the light through a first optical element having double concave lens and a negative optical power, the first optical element having a first surface and a second surface wherein the second surface of the first optical element is aspherical; directing the light through a second optical element having a positive meniscus formed with a concave surface facing towards the object and with a positive optical power, the second optical element having a first surface and a second surface wherein the first surface of the second optical element is aspherical; directing the light through a third optical element having a positive meniscus formed with a concave surface facing towards the image plane detector and with a positive optical power, the third optical element having a first surface and a second surface wherein the second surface of the third optical element is aspherical; directing the light through a fourth optical element having a negative meniscus formed with a concave surface facing towards the object and with a negative optical power; and directing the light through a fifth optical element having a positive meniscus formed with a concave surface facing towards the object and with a positive optical power, the fifth optical element having a first surface and a second surface wherein the first surface of the fifth optical element is aspherical. Optional steps may include that the steps of directing the light through the first set of optical elements and directing the light through the second set of optical elements further comprises: directing the light through a first optical element having a negative meniscus formed with a concave surface facing towards the image plane detector and with a negative optical power, the first optical element having a first surface and a second surface wherein the second surface of the first optical element is aspherical; directing the light through a second optical element having a positive meniscus formed with a concave surface facing towards the object and with a positive optical power, the second optical element having a first surface and a second surface wherein the first surface of the second optical element is aspherical; directing the light through a third optical element having a positive meniscus formed with a concave surface facing towards the image plane detector and with a positive optical power, the third optical element having a first surface and a second surface wherein the second surface of the third optical element is aspherical; directing the light through a fourth optical element having a negative meniscus formed with a concave surface facing towards the object and with a negative optical power; and directing the light through a fifth optical element having a positive meniscus formed with a concave surface facing towards the object and with a positive optical power, the fifth optical element having a first surface and a second surface wherein the first surface of the fifth optical element is aspherical.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A mid-wave infrared (MWIR) lens assembly, comprising:
a first set of optical elements, wherein each optical element of the first set of optical elements is a positive optical power;
a second set of optical elements, wherein each optical element of the second set of optical elements is a negative optical power;
a cold shield positioned optically behind the first set of optical elements and the second set of optical elements relative to a direction that light waves move through the first set and the second set of optical elements; and
an image plane detector positioned optically behind the first set of optical elements, the second set of optical elements, and the cold shield;
wherein at least one optical element of the first set of optical elements is formed of a first optical glass material, at least another optical element of the first set of optical elements is formed of a second optical glass material, and at least one optical element of the second set of optical elements is formed of a third optical glass material;
wherein the second optical glass material is different than the first optical glass material and the third optical glass material.

2. The MWIR lens assembly of claim 1, wherein the first set of optical elements and the second set of optical elements further comprises:
five total optical elements with two optical elements in the first set of optical elements and three optical elements in the second set of optical elements.

3. The MWIR lens assembly of claim 2, wherein the five total optical elements of the first set of optical elements and the second set of optical elements are arranged in order from an object to the image plane detector as a first optical element having a negative optical power, a second optical element having a positive optical power, a third optical element having a positive optical power, a fourth optical power having a negative optical power, and a fifth optical power having a positive optical power.

4. The MWIR lens assembly of claim 3, wherein:
the first optical glass material further comprises a Germanium material;
the second optical glass material further comprises a Silicon material; and
the third optical glass material further comprises a Germanium material.

5. The MWIR lens assembly of claim 4, wherein the third optical element is made from the first optical glass material, the second optical element and the fifth optical element are made from the second optical glass material, and the first optical element and the fourth optical element are made from the third optical glass material.

6. The MWIR lens assembly of claim 4, wherein the first optical element further comprises:
a double concave lens having a first surface of the first optical element that is oriented towards the object and a second surface of the first optical element that is oriented opposite towards the image plane detector;
wherein the second surface of the first optical element that is formed aspherical.

7. The MWIR lens assembly of claim 6, wherein the second optical element further comprises:
a positive meniscus lens having a first surface of the second optical element that is oriented towards the object and a second surface of the second optical element that is oriented opposite towards the image plane detector;
wherein the first surface of the second optical element is a concave surface of the positive meniscus lens and is formed aspherical.

8. The MWIR lens assembly of claim 7, wherein the third optical element further comprises:
a positive meniscus lens having a first surface of the third optical element that is oriented towards the object and a second surface of the third optical element that is oriented towards the image file detector;
wherein the second surface of the third optical element is a concave surface of the positive meniscus lens and is formed aspherical.

9. The MWIR lens assembly of claim 8, wherein the fourth optical element further comprises:
a negative meniscus lens having a first surface of the fourth optical element that is oriented towards the object and a second surface of the fourth optical element that is oriented towards the image plane detector;
wherein the second surface of the fourth optical element that is a concave surface of the negative meniscus lens.

10. The MWIR lens assembly of claim 9, wherein the fifth optical element further comprises:
a positive meniscus lens having a first surface of the fifth optical element that is oriented towards the object and a second surface of the fifth optical element that is oriented opposite towards the image plane detector;
wherein the first surface is a concave surface of the positive meniscus lens and is formed aspherical.

11. The MWIR lens assembly of claim 10, further comprising:
an orthoscopic lens with residual distortion not exceeding 0.03% over a full field of view; and
a F # of 2.2.

12. The MWIR lens assembly of claim 4, wherein the first optical element further comprises:
a negative meniscus lens having a first surface of the first optical element oriented towards the object and a second surface of the first optical element oriented towards the image file detector;
wherein second surface of the first optical element is a concave surface of the negative meniscus lens and is formed aspherical.

13. The MWIR lens assembly of claim 12, wherein the second optical element further comprises:
a positive meniscus lens having a first surface of the second optical element oriented towards the object and a second surface of the second optical element oriented towards the image plane detector;
wherein the first surface is a concave surface of the positive meniscus lens and is formed aspherical.

14. The MWIR lens assembly of claim 13, wherein the third optical element further comprises:
a positive meniscus lens having a first surface of the third optical element oriented towards the object and a second surface of the third optical element oriented towards the image file detector;
wherein the second surface is a concave surface of the positive meniscus lens and is formed aspherical.

15. The MWIR lens assembly of claim 14, wherein the fourth optical element further comprises:
a negative meniscus lens having a first surface of the fourth optical element oriented towards the image plane detector and a second surface of the fourth optical element oriented towards the image plane detector;
wherein the first surface is a concave surface of the negative meniscus lens.

16. The MWIR lens assembly of claim 15, wherein the fifth optical element further comprises:
a positive meniscus lens having a first surface of the fifth optical element oriented towards the object and a second surface of the fifth optical element oriented towards the image plane detector;
wherein the first surface is a concave surface of the positive meniscus lens and is formed aspherical.

17. The MWIR lens assembly of claim 16, further comprising:
an orthoscopic lens with residual distortion not exceeding 0.1% over a full field of view; and
a F # of 2.

18. A method, comprising:
receiving light emitted from an object;
directing the light through a first set of optical elements, wherein each optical element of the first set of optical elements has a positive optical power with at least one optical element of the first set of optical elements formed a first optical glass material and at least another optical element of the first set of optical elements formed of a second optical glass material;
directing the light through a second set of optical elements, wherein each optical element of the second set of optical elements has a negative optical power with at least one optical element of the second set of optical elements formed a third optical glass material; wherein the second optical glass material is different than the first optical glass material and the third optical glass material;
directing the light with an image plane detector; and
generating an image from the image plane detector.

19. The method of claim 18, wherein the steps of directing the light through the first set of optical elements and directing the light through the second set of optical elements further comprises:
directing the light through a first optical element having double concave lens and a negative optical power, the first optical element having a first surface and a second surface wherein the second surface of the first optical element is aspherical;
directing the light through a second optical element having a positive meniscus formed with a concave surface facing towards the object and with a positive optical power, the second optical element having a first surface and a second surface wherein the first surface of the second optical element is aspherical;
directing the light through a third optical element having a positive meniscus formed with a concave surface facing towards the image plane detector and with a positive optical power, the third optical element having a first surface and a second surface wherein the second surface of the third optical element is aspherical;
directing the light through a fourth optical element having a negative meniscus formed with a concave surface facing towards the object and with a negative optical power; and
directing the light through a fifth optical element having a positive meniscus formed with a concave surface facing towards the object and with a positive optical power, the fifth optical element having a first surface and a second surface wherein the first surface of the fifth optical element is aspherical.

20. The method of claim 18, wherein the steps of directing the light through the first set of optical elements and directing the light through the second set of optical elements further comprises:
directing the light through a first optical element having a negative meniscus formed with a concave surface facing towards the image plane detector and with a negative optical power, the first optical element having a first surface and a second surface wherein the second surface of the first optical element is aspherical;
directing the light through a second optical element having a positive meniscus formed with a concave surface facing towards the object and with a positive optical power, the second optical element having a first surface and a second surface wherein the first surface of the second optical element is aspherical;
directing the light through a third optical element having a positive meniscus formed with a concave surface facing towards the image plane detector and with a positive optical power, the third optical element having a first surface and a second surface wherein the second surface of the third optical element is aspherical;
directing the light through a fourth optical element having a negative meniscus formed with a concave surface facing towards the object and with a negative optical power, and
directing the light through a fifth optical element having a positive meniscus formed with a concave surface facing towards the object and with a positive optical power, the fifth optical element having a first surface and a second surface wherein the first surface of the fifth optical element is aspherical.
